(19) United States
(12) Patent Application Publication
(10) Pub. No.: US 2025/0360660 A1
(43) Pub. Date: Nov. 27, 2025

(54) COMPRESSION MOLDED DOUBLE WALL BLOCKS FOR A PALLET AND ASSOCIATED METHODS

(71) Applicant: CHEP Technology Pty Limited, Sydney (AU)

(72) Inventors: Christopher John GEROU, Alpharetta, GA (US); Mark Christian TOLMAY, Alpharetta, GA (US)

(21) Appl. No.: 19/286,980

(22) Filed: Jul. 31, 2025

Related U.S. Application Data
(63) Continuation-in-part of application No. 17/820,598, filed on Aug. 18, 2022.
(60) Provisional application No. 63/239,501, filed on Sep. 1, 2021.

(51) Int. Cl. B29C 43/08; B29C 43/14; B29C 43/34; B29C 43/52; B29K 311/14; B29L 22/00; B29L 31/00

(52) U.S. Cl. CPC B29C 43/08; B29C 43/14; B29C 43/34; B29C 2043/3433; B29C 2043/527; B29K 2311/14; B29L 2022/00; B29L 2031/7178

(57) ABSTRACT

A compression molding system includes a first extruder configured to output melted plastic, a second extruder downstream from the first extruder and configured to mix the melted plastic with wood chips to output a composite material, a splitter downstream from the second extruder and configured to split a flow of the composite material between a first flow and a second flow, and an inner and outer block transfer valve downstream from the splitter and configured to receive the first flow and the second flow of the composite material. An inner block transfer valve and an outer block transfer valve may be configured to alternately direct the composite material between an inner block accumulator and an outer block accumulator.

### CROSS-REFERENCE TO RELATED APPLICATIONS

This application claims the benefit of U.S. non-provisional application Ser. No. 17/820,598, filed Aug. 18, 2022, which claims the benefit of U.S. provisional application Ser. No. 63/239,501, filed Sep. 1, 2021, both of which are hereby incorporated herein in their entireties by reference.

### TECHNICAL FIELD

The present disclosure relates to the field of pallets, and more particularly, to double wall blocks for a pallet and related methods for making the same.

### BACKGROUND

Conventional pallets are typically made of wood and include a bottom deck and a top deck separated by support blocks. The support blocks form a gap between the bottom and top decks for receiving a lifting member, such as tines from a forklift or pallet jack.

The top deck is typically multiple layers where end deck boards are assembled on connector boards that run the full length or width of the pallet. The end deck boards are nailed through the connector boards into the support blocks to build the primary structure of the pallet. The end deck boards are also known as lead boards. Intermediate deck boards are placed between the end deck boards. The base layer is typically a single layer where the end deck boards do not overlap connector boards.

To move the pallet with cargo thereon, the tines from a forklift or pallet jack are inserted into the gaps between the bottom and top decks. Depending on the operator of the forklift or pallet jack, the tines may make contact with the support blocks during alignment with the gaps. If the force is significant, the support blocks may be damaged.

The support blocks are generally solid wood. Solid wood support blocks provide good strength and durability. Depending on their size, solid wood support blocks can be heavy which adds to the final weight of the pallet. The cost of each solid wood support block is typically based on its volume and the type of wood used.

The inventors have identified numerous deficiencies and problems with the existing technologies in this field. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

A compression molding system includes a first extruder to output melted plastic, and a second extruder downstream from the first extruder and configured to mix the melted plastic with wood chips to output a composite material. A transfer valve is downstream from the second extruder to alternately direct the composite material between an inner block output and an outer block output associated with the transfer valve.

At least one inner block assembly includes at least one inner block mold to receive the composite material from the inner block output associated with the transfer valve, and at least one inner block press aligned with the at least one inner block mold to press the composite material in the at least one inner block mold into a desired shape of at least one inner block having an opening on one side. At least one outer block assembly includes at least one outer block mold to receive the composite material from the outer block output associated with the transfer valve, and at least one outer block press aligned with the at least one inner block mold to press the composite material in the at least one outer block mold into a desired shape of at least one outer block having an opening on one side.

A press assembly is downstream from the at least one inner and outer block assemblies, and presses one of the at least one inner blocks into the opening in one of the at least one outer blocks to form a double wall block.

The compression molding system may further include an inner block carousel and an outer block carousel. The at least one inner block assembly may include a plurality of inner block assemblies spaced apart on the inner block carousel. The at least one outer block assembly may include a plurality of outer block assemblies spaced apart on the outer block carousel. The inner and outer block carousels are configured to rotate, with the composite material alternately being deposited into the at least one inner and outer block molds as they become available on their respective inner and outer block carousels.

The compression molding system may further include an inner block coolant system and an outer block coolant system. The inner block coolant system circulate a coolant through each inner block mold when the composite material therein is under pressure by the at least one inner block press associated therewith. The outer block coolant system circulates a coolant through each outer block mold when the composite material therein is under pressure by the at least one outer block press associated therewith.

The inner and outer block molds may be cooled while under pressure to allow the composite material to stabilize in order for the inner and outer blocks to be removed from their respective inner and outer block molds without being soft and sagging.

The compression molding system may further include a robot arm positioned between the inner and outer block mold assemblies, and is configured to alternately engage the at least one inner block and the at least one outer block as they exit the at least one inner and outer block molds. An inner block conveyor is positioned between the robot arm and the press assembly to receive the at least one inner block from the robot arm. An outer block conveyor is adjacent the inner block conveyor and is positioned between the robot arm and the press assembly to receive the at least one outer block from the robot arm. The press assembly may receive the at least one inner block and the at least one outer block from the inner and outer block conveyors.

The compression molding system may further comprising a first chilled sprayer adjacent the inner and outer block conveyors, and configured to cool the at least one inner and outer blocks as they travel on the respective inner and outer block conveyors to the press assembly.

The compression molding system may further include a single conveyor to receive the double wall block from the press assembly. A second chilled sprayer may be adjacent the single conveyor to cool the double wall block as it travels on the single conveyor.

A temperature of the outer block in the double wall block may be warmer than a temperature of the inner block in the double wall block, and as the outer block cools, the outer block shrinks onto the inner block to create a tight seal at an interface between the inner and outer blocks.

The composite material may be about 50% plastic and about 50% wood. The double wall block may be formed with a hollow center. The inner block may be configured as a 5-sided block with the opening on a remaining side, and the outer block may be configured as a 5-sided block with the opening on a remaining side. The inner and outer blocks may be oriented so that the opening of the inner block is facing the opening of the outer block.

Yet another aspect is directed to a compression press including a frame, a movable lid carried by the frame and having an opening extending therethrough, and a core movable between a retracted position and an extended position (e.g., a partially extended position and/or a fully extended position). The core is aligned with the opening in the lid.

A first hydraulic stage is carried by the frame and is configured to move the core from the retracted position to the partially extended position, with the core in the partially extended position extending through the opening in the lid, and move the lid and the core in the partially extended position to contact a mold having a cavity with material deposited therein. Pressure is applied to the lid and the core in the fully extended position within the cavity causing the material to spread out and form an object having a desired shape within the mold. A second hydraulic stage is carried by the frame and is configured to apply additional pressure on the lid and the core in the fully extended position within the cavity.

In various aspects, a compression molding system includes a first extruder configured to output melted plastic, a second extruder downstream from the first extruder and configured to mix the melted plastic with wood chips to output a composite material, a splitter downstream from the second extruder and oriented to split a flow of the composite material between a first flow and a second flow, an inner block transfer valve downstream from the splitter and oriented to receive the first flow of the composite material, an outer block transfer valve downstream from the splitter and oriented to receive the second flow of the composite material, an inner block accumulator that is downstream from the inner block transfer valve, an outer block accumulator that is downstream from the outer block transfer valve, wherein the inner block transfer valve and the outer block transfer valve are configured to alternately direct the composite material between the inner block accumulator and the outer block accumulator, at least one inner block assembly comprising at least one inner block mold to receive the composite material from the inner block accumulator, and at least one inner block press oriented to press the composite material in the at least one inner block mold into a desired shape of at least one inner block having an opening on one side, at least one outer block assembly comprising at least one outer block mold to receive the composite material from the outer block accumulator, and at least one outer block press oriented to press the composite material in the at least one outer block mold into a desired shape of at least one outer block having an opening on one side, and a press assembly downstream from the at least one inner and outer block assemblies, and oriented to press one of the at least one inner blocks into the opening in one of the at least one outer blocks to form a double wall block.

In various examples, the compression molding system further comprises an inner block carousel, wherein the at least one inner block assembly comprises a plurality of inner block assemblies spaced apart on the inner block carousel, and an outer block carousel, wherein the at least one outer block assembly comprises a plurality of outer block assemblies spaced apart on the outer block carousel, wherein the inner and outer block carousels are configured to rotate, with the composite material alternately being deposited into the at least one inner and outer block molds as they become available on their respective inner and outer block carousels.

In various examples, each inner block assembly is configured to move the respective inner block mold to a first position that is under the inner block accumulator to receive the composite material and to a second position that is under the respective inner block press.

In various examples, the compression molding system further comprises an inner block coolant system configured to circulate a coolant through each inner block mold when the composite material therein is under pressure by the at least one inner block press associated therewith, and an outer block coolant system configured to circulate a coolant through each outer block mold when the composite material therein is under pressure by the at least one outer block press associated therewith.

In various examples, cooling the inner and outer block molds while under pressure allows the composite material to stabilize in order for the inner and outer blocks to be removed from their respective inner and outer block molds without being soft and sagging.

In various examples, the compression molding system further comprises an inner block robot arm positioned proximate to the inner block mold assembly, the inner block robot arm configured to engage the at least one inner block as it exits the at least one inner block mold, and a block conveyor positioned to receive the at least one inner block from the inner block robot arm.

In various examples, the compression molding system further comprises an outer block robot arm positioned proximate to the outer block mold assembly, the outer block robot arm configured to engage the at least one outer block as it exits the at least one outer block molds, wherein the block conveyor is positioned to receive the at least one outer block from the outer block robot arm, and wherein the press assembly is oriented to receive the at least one inner block and the at least one outer block from the block conveyor.

In various examples, the compression molding system further comprises an inner block chilled sprayer proximate to the block conveyor, and configured to cool the at least one inner block as they travel on the block conveyor to the press assembly.

In various examples, the compression molding system further comprises a block chilled sprayer proximate to the block conveyor, and configured to cool the at least one outer block as they travel on the block conveyor to the press assembly.

In various examples, the compression molding system further comprises a double wall block conveyor to receive the double wall block from the press assembly, and a double wall block chilled sprayer adjacent the double wall block conveyor, and configured to cool the double wall block as it travels on the double wall block conveyor.

In various examples, a temperature of the outer block in the double wall block is warmer than a temperature of the inner block in the double wall block, and as the outer block cools, the outer block shrinks onto the inner block to create a tight seal at an interface between the inner and outer blocks.

In various examples, the composite material is about 50% plastic and about 50% wood. In various examples, the double wall block is formed with a hollow center.

In various examples, the inner block is configured as a 5-sided block with the opening on a remaining side, and the outer block is configured as a 5-sided block with the opening on a remaining side, with the inner and outer blocks being oriented so that the opening of the inner block is facing the opening of the outer block.

In various examples, the inner block accumulator comprises a plunger and defines a cavity, and wherein the plunger is configured to be pulled back so that the first flow of the composite material is received into the cavity of the inner block accumulator.

In various examples, the inner block accumulator comprises a nozzle, and wherein the plunger is configured to be pushed forward to push the first flow of the composite material from the cavity and through the nozzle.

In various examples, an inner block mold that is to receive the first flow of the composite material is positioned below the inner block accumulator.

In various examples, the compression molding system further comprises a robot arm positioned proximate to the inner block mold assembly, the robot arm comprising an end effector that is configured to engage a pair of inner block molds from the at least one inner block assembly.

In various examples, the end effector comprises two pairs of fingers, and wherein at least one of the fingers of each pair of fingers is configured to move towards the other finger to engage a block of the pair of blocks.

In various examples, the compression molding system further comprises an inner block robot arm positioned proximate to the inner block mold assembly, the inner block robot arm configured to engage the at least one inner block as it exits the at least one inner block mold, an outer block robot arm positioned proximate to the outer block mold assembly, the outer block robot arm configured to engage the at least one outer block as it exits the at least one outer block molds, and a block conveyor positioned to receive the at least one inner block from the inner block robot arm and the at least one outer block from the outer block robot arm, wherein the inner block robot arm and the outer block robot arm are configured to pair and position the at least one inner block with at least one outer block such that they are laterally aligned on the block conveyor.

Other aspects are directed to a method of operating the compression molding system as described above, and to a method of operating the compression press as described above.

### BRIEF DESCRIPTION OF THE DRAWINGS

Having thus described certain example embodiments of the present disclosure in general terms above, non-limiting and non-exhaustive embodiments of the subject disclosure are described with reference to the following figures, which are not necessarily drawn to scale and wherein like reference numerals refer to like parts throughout the various views unless otherwise specified. The components illustrated in the figures may or may not be present in certain embodiments described herein. Some embodiments may include fewer (or more) components than those shown in the figures.

FIG. 1 is a perspective view of a compression molded inner block, in accordance with an example embodiment.

FIG. 2 is a perspective view of a compression molded outer block, in accordance with an example embodiment.

FIGS. 3 and 4 are perspective views of the compression molded inner and outer blocks illustrated in FIGS. 1 and 2 being aligned and pushed together to form a double wall block, in accordance with an example embodiment.

FIGS. 5 and 6 are cross-sectional side views of the compression molded inner and outer blocks illustrated in FIGS. 1 and 2 being aligned and pushed together to form a double wall block, in accordance with an example embodiment.

FIG. 7 is a cross-sectional side view of the double wall block illustrated in FIG. 4, in accordance with an example embodiment.

FIG. 8 is a perspective view of a compression molded inner and outer block being aligned and pushed together to form a double wall block, in accordance with an example embodiment.

FIG. 9 is a top view of the compression molded inner and outer block of FIG. 8 being aligned and pushed together to form the double wall block, in accordance with an example embodiment.

FIG. 10 is a perspective view of the double wall block that includes the inner and outer block of FIG. 8, in accordance with an example embodiment.

FIG. 11 is a block diagram of a compression molding system for forming compression molded inner and outer blocks and a double wall block, in accordance with an example embodiment.

FIG. 12 is a block diagram of a compression molding system for forming compression molded inner and outer blocks and a double wall block, in accordance with an example embodiment.

FIG. 13 is a top view of a portion of the compression molding system of FIG. 12, in accordance with an example embodiment.

FIG. 14 is a cross-sectional side view of the portion of the compression molding system of FIG. 13, in accordance with an example embodiment.

FIG. 15 is a side view of a portion of the compression molding system of FIG. 12, in accordance with an example embodiment.

FIG. 16 is a side view of a portion of the compression molding system of FIG. 12, in accordance with an example embodiment.

FIG. 17 is a side view of the portion of the compression molding system of FIG. 16, in accordance with an example embodiment.

FIG. 18 is a side view of a portion of the compression molding system of FIG. 12, in accordance with an example embodiment.

FIG. 19 is a side view of the portion of the compression molding system of FIG. 18, in accordance with an example embodiment.

FIG. 20 is a side view of a portion of the compression molding system of FIG. 12, in accordance with an example embodiment.

FIGS. 21-24 illustrate operation of how the composite material is deposited into the respective inner and outer block mold cavities, in accordance with an example embodiment.

FIGS. 25-33 illustrate operation the multi-stage compression press used to form the inner and outer blocks illustrated in FIGS. 1-10, in accordance with an example embodiment.

FIG. 34 illustrates operation of the robot arm used to remove the inner blocks from the multi-stage compression press illustrated in FIG. 13, in accordance with an example embodiment.

FIG. 35 is an isometric view of an end effector of a robot arm, in accordance with an example embodiment.

FIG. 36 is an isometric view of a portion of the compression molding system of FIG. 12, in accordance with an example embodiment.

FIG. 37 is an isometric view of a portion of the compression molding system of FIG. 12, in accordance with an example embodiment.

FIG. 38 is an isometric view of a portion of the compression molding system of FIG. 12, in accordance with an example embodiment.

FIG. 39 is a perspective view of the double wall block having a logo formed during the compression molding process, in accordance with an example embodiment.

FIG. 40 is a flow diagram on operating the compression molding system illustrated in FIG. 11, in accordance with an example embodiment.

FIG. 41 is a flow diagram on operating the compression molding system illustrated in FIG. 12, in accordance with an example embodiment.

FIG. 42 is a flow diagram on operating the compression press illustrated in FIGS. 25-33, in accordance with an example embodiment.

### DETAILED DESCRIPTION

One or more embodiments are now more fully described with reference to the accompanying drawings, wherein like reference numerals are used to refer to like elements throughout and in which some, but not all embodiments of the inventions are shown. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements.

As used herein, the term “exemplary” means serving as an example, instance, or illustration. Any aspect or design described herein as “exemplary” is not necessarily to be construed as preferred or advantageous over other aspects or designs. Rather, use of the word exemplary is intended to present concepts in a concrete fashion. In addition, while a particular feature may be disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the term “positioned directly on” refers to a first component being positioned on a second component such that they make contact. Similarly, as used herein, the term “positioned directly between” refers to a first component being positioned between a second component and a third component such that the first component makes contact with both the second component and the third component. In contrast, a first component that is “positioned between” a second component and a third component may or may not have contact with the second component and the third component. Additionally, a first component that is “positioned between” a second component and a third component is positioned such that there may be other intervening components between the second component and the third component other than the first component.

As used herein, the term “proximate to,” “near,” or the like, refers to a first component being positioned within three inches, such as within two inches, such as within 1 inch, of the other component or area specified.

As used herein, terms of approximation, such as “approximately,” “substantially,” or “about,” refer to being within manufacturing or engineering tolerances. For example, terms of approximation may refer to being within a five percent margin of error.

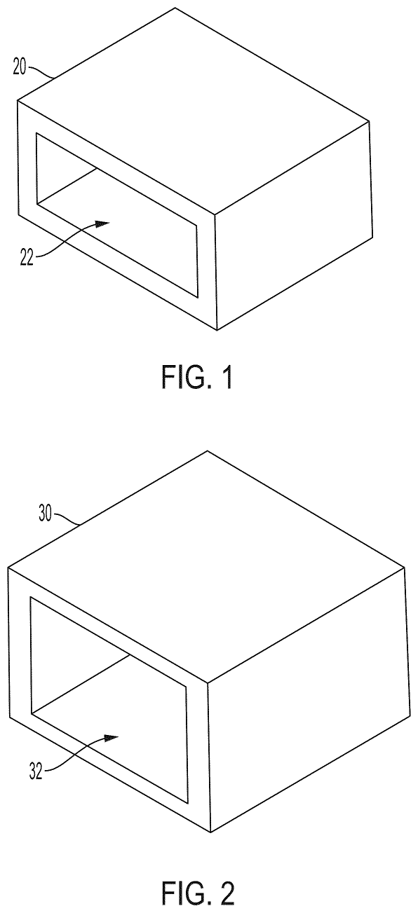

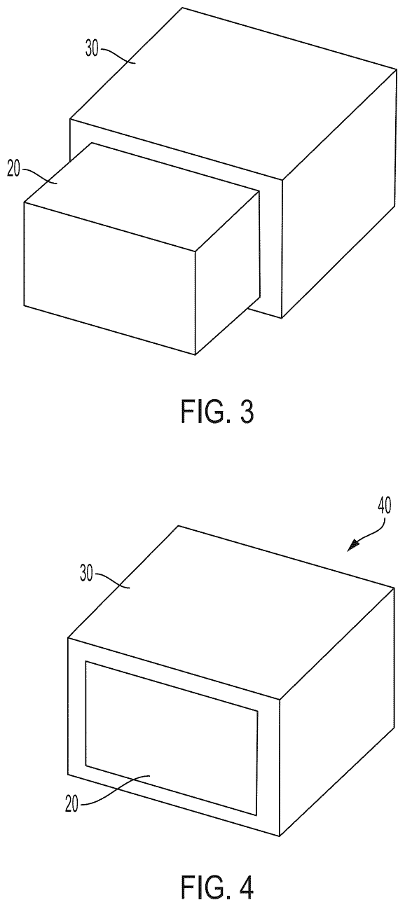

Referring initially to FIGS. 1 and 2, and as will be discussed in greater detail below, compression molding may be used to form inner and outer blocks 20, 30 for use with pallets. The inner block 20 may be a 5-sided block with an opening 22 on the remaining side. The outer block 30 may be a 5-sided block with an opening 32 on the remaining side. Shortly after the inner and outer blocks 20, 30 are formed, the inner block 20 may be inserted into the opening 32 of the outer block 30 to form a compression molded double wall block 40, as illustrated in FIGS. 3 and 4. The compression molded double wall block 40 may also be referred to as a double wall block or as a support block.

Depending on the orientation of the inner block 20, the double wall block 40 may have 4 or 5 sides that have double walls. A double wall block 40 with 5 sides occurs when the inner block 20 is placed into the outer block 30 such that the cavity of the inner block 20 is exposed. The side opposite the opening 22 would be the 5th double wall. A pallet with double wall blocks 40 having a hollow center may reduce the weight of the pallet as compared to the use of solid wood blocks while also providing durability and strength.

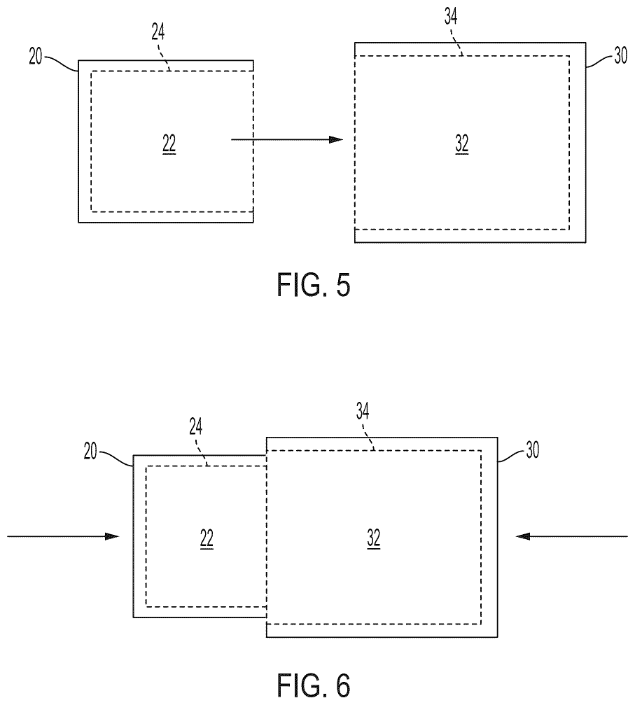

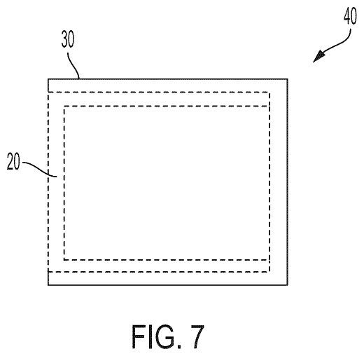

In one configuration, the inner and outer blocks 20, 30 may be oriented such that the opening 22 of the inner block 20 is facing the opening 32 of the outer block 30, as illustrated in FIG. 5. The side views of the inner and outer blocks 20, 30 include dashed lines 24, 34 to show wall thicknesses of each respective block. In this configuration, the double wall block 40 has 4 sides having double walls.

Soon after the inner and outer blocks 20, 30 have been formed, and as they are cooling, the inner block 20 may be inserted into the opening 32 of the outer block 30 to form the double wall block 40, as illustrated in FIG. 6. As will be discussed in greater detail below, the inner block 20 may be pre-cooled before being inserted into the warmer outer block 30. After the double wall block 40 has been formed, a chilled spray may continue to cool the warmer outer block 30 so that the outer block 30 shrinks onto the inner block 20 while creating a seal, such as a hermetic seal.

In various configurations, orientation of the inner block 20 may be rotated 90 or 180 degrees before being inserted into the opening 32 of the outer support block 30. This may allow the double wall block 40 to have 5 sides having double walls so as to provide increased durability.

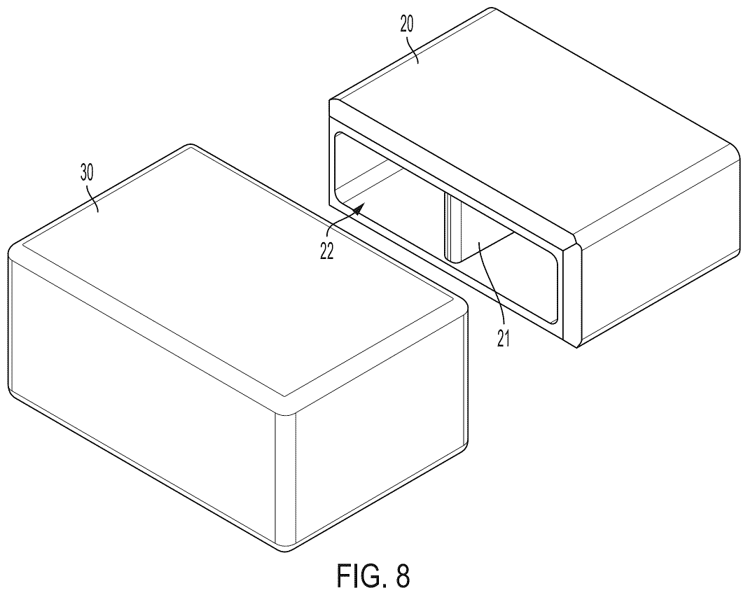

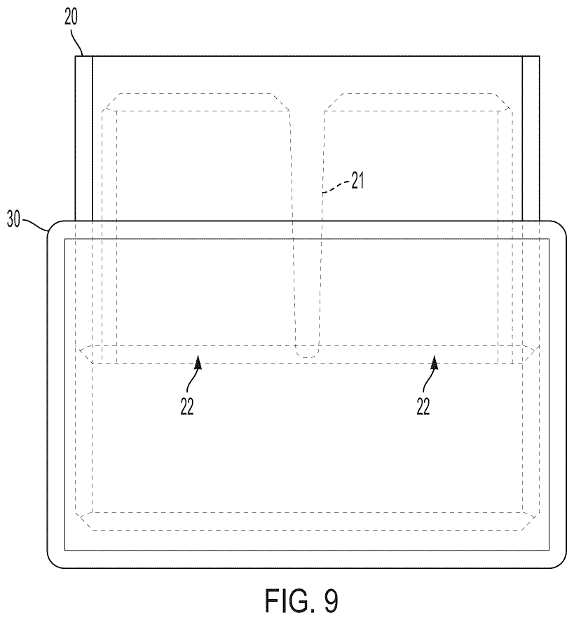

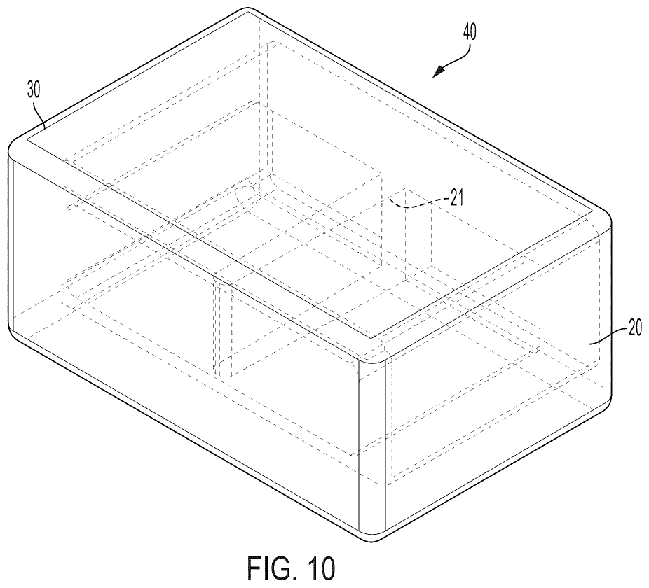

Referring now to FIGS. 8-10, views of a double wall block 40 are provided, in accordance with an example embodiment. In various examples, the inner block 20 may comprise at least one rib 21, such as one, two, three, four or more ribs 21. Each rib 21 may be positioned within the opening 22 of the inner block 20. Each rib 21 may extend inward into the opening 22 and from the side that is opposite to an entrance to the opening 22. Each rib 21 may be monolithic with a floor and a ceiling of the inner block 20, as depicted. Each rib may be monolithic with a wall, such as a vertical wall of the inner block 20. For example, each rib may be monolithic with two opposing side walls of the inner block 20 that extend vertically or with the back wall of the inner block 20 that extends vertically. In various examples, the inner block 20 may include at least two ribs that intersect orthogonally.

In various examples, each rib 21 is tapered. For example, a proximal end of each rib 21 may have a thickness that is greater than a thickness at a distal end of the rib 21. Tapering each rib 21 may facilitate the removal of the inner block 20 from an inner block mold 102, which will be discussed in more detail. In various examples, each rib 21 is not tapered and has a constant thickness along a length of the rib 21.

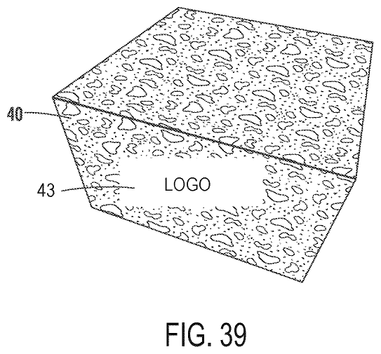

Referring now to FIG. 39, a double wall block 40 may be configured to have a logo 43. The outer block mold cavity 124 may be modified to have a raised surface in the shape of the logo 43 on one or more of the sidewalls of the cavity 124.

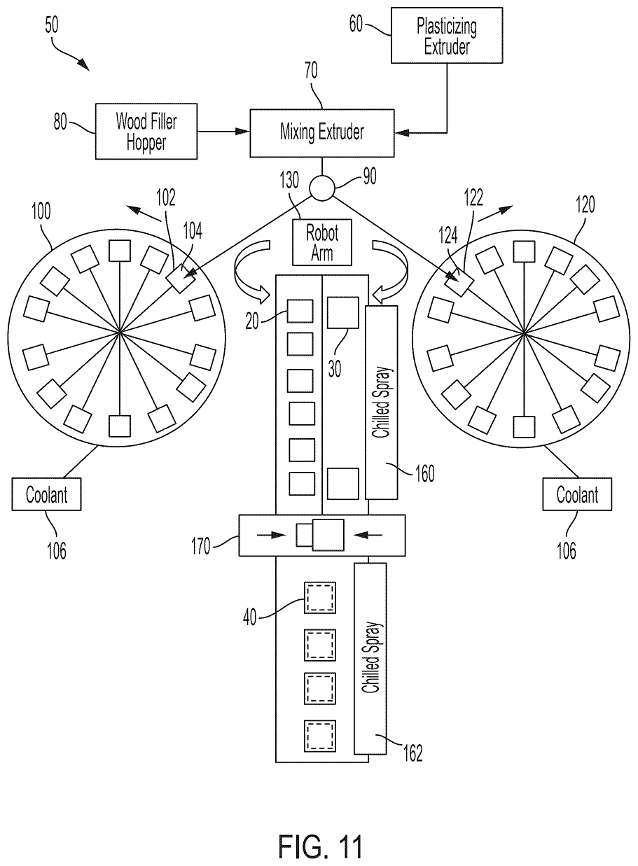

Referring now to FIG. 11, a schematic view of a compression molding system 50 used to form the double wall blocks 40 is provided, in accordance with an example embodiment. The compression molding system 50 may include a pair of extruders. A first extruder may be a plasticizing extruder 60 that receives recycled thermal plastic and melts the plastic. Recycled thermal plastic is cost effective, but as an alternative, non-recycled (i.e., virgin) thermal plastic may be used. The melted plastic may then be transferred to a second extruder, which may be a mixing extruder 70. The mixing extruder 70 may mix the melted plastic with wood chips received from a wood filler hopper 80 to form a composite material. An output of the mixing extruder 70 may direct the composite material to a transfer valve 90.

Plasticizing the recycled thermal plastic before adding the wood chips may be beneficial. For example, a problem of plasticizing the recycled thermal plastic and wood chips at the same time is that the temperature needed to plasticize the recycled thermal plastic may cause the wood chips to burn. A temperature sufficient to heat and extrude the plastic so that it reaches a molten state may be beneficial. For example, heating the plastic to a temperature of at least 250 degrees Fahrenheit and up to 500 degrees Fahrenheit, such as about 370 degrees Fahrenheit may be needed to melt the plastic. When the wood chips are added before the plastic is melted, the wood chips may reduce the efficiency of the extruder or cause thermal destruction of the wood chips.

In the mixing extruder 70, the wood chips may be added to the melted plastic before entering a compression section of the mixing extruder 70. For example, the wood fibers may be fully wetted and mixed with the molten plastic to form a composite material for the compression molding process. The wood chips may act as a coolant to cool the temperature of the melted plastic to a temperature that is ideal for compression molding. The temperature of the melted plastic may be reduced from the temperature needed to heat and extrude the plastic. For example, the temperature of the melted plastic may be reduced from about 400 degrees Fahrenheit to about 350 degrees Fahrenheit. At this reduced temperature, the composite material has been mixed with fully wetted wood fibers glued together at a temperature that may not have started to gas or cause thermal destruction of the wood chips.

In various examples, and as illustrated in FIG. 11, two carousels 100, 120 are used to allow for a continuous compression molding process. An inner block carousel 100 may be used for the inner blocks 20, and an outer block carousel 120 may be used for the outer blocks 30. The transfer value 90 may alternately direct the composite material between an inner block output associated with the transfer value 90 for the inner block molds 102 on the inner block carousel 100, and an outer block output associated with the transfer value 90 for the outer block molds 122 on the outer block carousel 120.

In various examples, the inner block carousel 100 includes a plurality of inner block assemblies spaced apart on the inner block carousel to form stations. As will be described in greater detail below, each inner block assembly may include at least one inner block mold 102 to receive the composite material from the inner block output associated with the transfer valve 90, and at least one inner block press aligned with the at least one inner block mold 102. The at least one inner block press may be configured to press the composite material in the at least one inner block mold 102 into a desired shape of at least one inner block 20 having an opening 22 on one side.

Similarly, the outer block carousel 120 may include a plurality of outer block assemblies spaced apart on the outer block carousel. As will be described in greater detail below, each outer block assembly may include at least one outer block mold 122 to receive the composite material from the outer block output associated with the transfer valve 90, and at least one outer block press aligned with the at least one inner block mold 122. The at least one outer block press may be configured to press the composite material in the at least one outer block mold 122 into a desired shape of at least one outer block 30 having an opening 32 on one side.

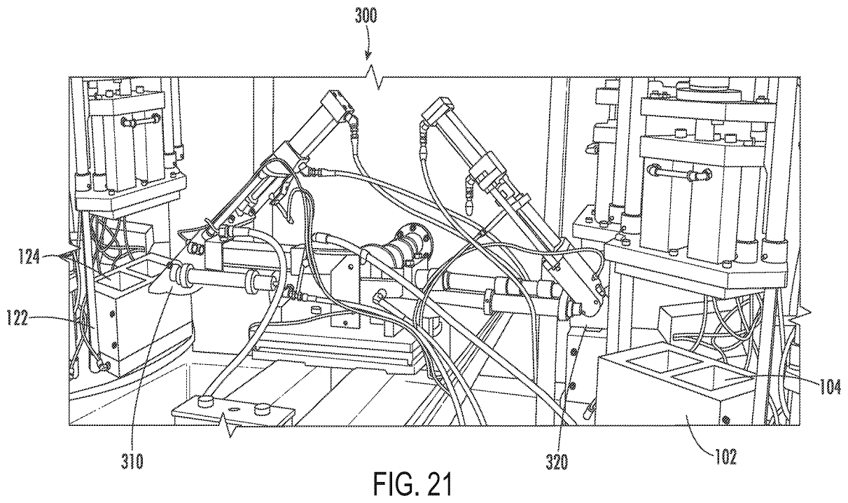

In various examples, a composite material shuttle 300 (FIG. 21) shuttles back and forth between the inner block carousel 100 and the outer block carousel 120. The composite material shuttle 300 may include a pair of spaced apart heads 310, 320 to deposit the composite material 202 when needed. The heads 310, 320 may be referred to as inner and outer block outputs.

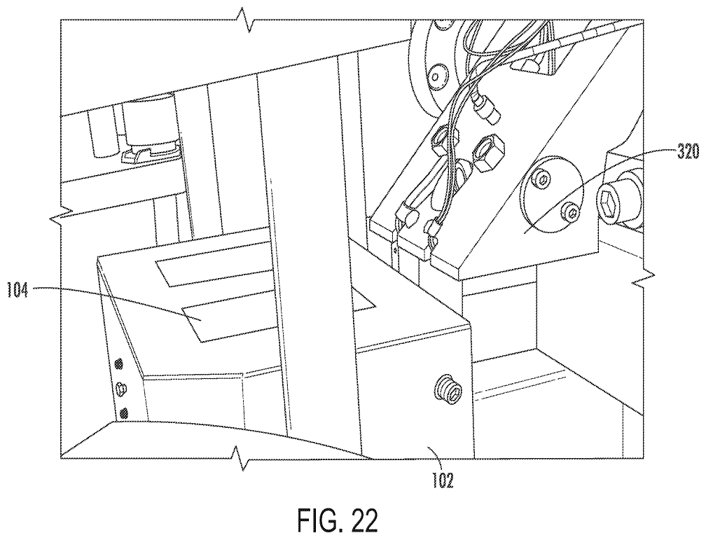

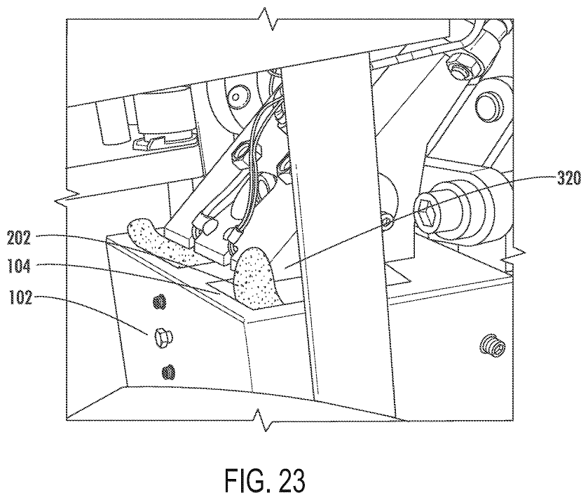

As illustrated in FIG. 22, the head 320 associated with the inner block carousel 100 may be aligned with an inner block mold 102. The head 320 may then be moved over the pair of inner block mold cavities 104 to deposit the composite material 202, as illustrated in FIG. 23.

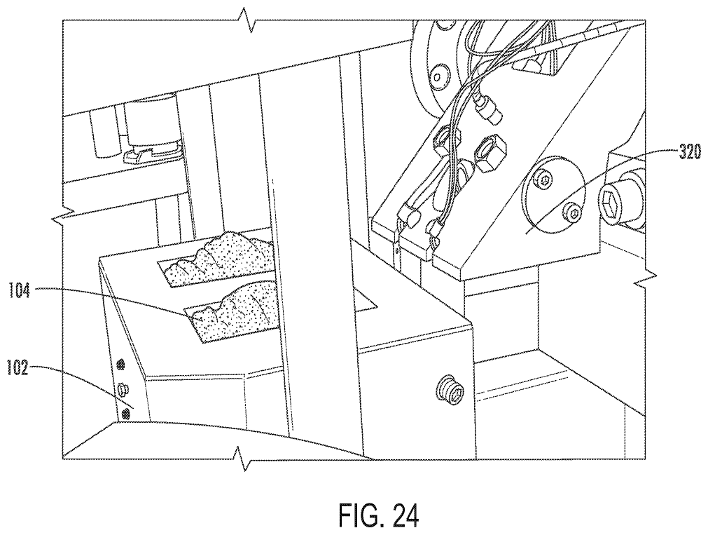

After the composite material 202 has been deposited, the head 320 may be moved away from the inner block mold 102, as illustrated in FIG. 24. The composite material 202 may now be ready to be compressed as discussed above using a multi-stage compression press 200, which will be discussed further.

As the inner block carousel 100 rotates and an inner block mold 102 becomes available, the transfer value 90 may direct a predetermined volume of composite material to be deposited into an inner block mold cavity 104. The inner block mold cavity 104 may then be closed using the inner block compression press associated therewith. The inner block compression press may drive a floating core into the inner block mold cavity 104. This may cause the composite material to flow into the desired shape of the inner block 20D.

After the floating core has compressed into the inner block mold cavity 104, the inner block carousel 100 may rotate. As the outer block carousel 120 rotates and an outer block mold 122 becomes available, the transfer value 90 directs a predetermined volume of composite material to be deposited into an outer block mold cavity 124. The outer block mold cavity 124 may then be closed using the outer block compression press associated therewith. The outer block compression press may drive a floating core into the outer block mold cavity 124. This may cause the composite material to flow into the desired shape of the outer block 30.

After the core has compressed into the outer block mold cavity 124, the outer block carousel 120 may rotate. During rotation, the transfer value 90 may direct the predetermined volume of composite material to be deposited into the next available inner block mold cavity 104. Alternating depositing of the composite material into the inner and outer block mold cavities 104, 124 may be a continuous process as the inner and outer block molds 102 become available on their respective carousels 100, 120.

In various examples, the compression molding system 50 is configured to consistently form inner blocks 20 and outer blocks 30. This may be based on a number of interdependencies between the materials, the equipment, and the process.

The ratio of plastic to wood used to form the inner and outer blocks may vary. In one example, the composite material from the mixing extruder 70 is about 50% plastic and about 50% wood. The ratio may be balanced to meet a desired mechanical characteristic of the double wall blocks, such as a nail retention of the double wall blocks. In various examples, the ratio of the wood within the composite material may vary between 20-80%, such as between 30-80%, such as between 30-50%, while the corresponding amount of plastic may vary between 70-50%. These example ratios are for illustration purposes and are not to be limiting.

The temperature of the composite material from the mixing extruder 70 may be about 300 or up to 450 degrees Fahrenheit. This may allow for the composite material to have a good mixture with a good consistency that flows well into the respective inner and outer mold cavities 104, 124.

In various examples, cooling of the composite material after having been deposited into the inner and outer molds 102, 122 is also a factor. Cooling of the inner and outer molds 102, 122 while under pressure may allow the composite material to set up hard enough (i.e., stabilize) in order to get the inner and outer blocks 20, 30 out of their respective molds without being soft and sagging.

The inner block carousel 100 and the outer block carousel 120 may be sized based on the coolant 106, 126 to allow sufficient time for the inner and outer blocks 20, 30 to cool as they are rotated. The coolant 106, 126 is chilled water, for example, that is circulated through the inner and outer block molds 102, 122. The number of molds on each carousel may be determined by how long it would take for the composite material to cool enough in order for the inner and outer blocks 20, 30 to be removed from their respective molds 102, 122.

In the illustrated compression molding system 50, the inner block carousel 100 has 14 molds 102 and the outer block carousel 120 has 14 molds 122. The molds on each carousel may be grouped into 7 stations, with each station having 2 molds. Both of the molds per station may be filled with the composite material at the same time.

As the inner block molds 102 are rotated, the floating core from the inner block compression press associated with each inner mold 102 may remain in the inner block mold cavity 104. Likewise, as the outer molds 122 are rotated, the floating core from the outer block compression press associated with each mold 122 may remain in the outer block mold cavity 124.

After the pair of inner block molds 102 within a station on the inner block carousel 100 reach a certain point within the rotation, the mold lid, connected stripper plate and respective floating cores, from the compression mold press may be removed from the inner block mold cavities 104, which in turn pulls the inner blocks 20 out of the cavities. As the inner blocks 20 cool, they may have a tendency to shrink onto the respective cores. Consequently, the inner blocks 20 may remain on the respective floating cores as the cores are removed from the inner block mold cavities 104.

In various examples, a robot arm 130 is positioned between the inner block carousel 100 and the outer block carousel 120. The robot arm 130 may be a swinging arm used to engage (e.g., grab, suction to, lift) the pair of inner blocks 20. The floating cores may be pulled up through a stripper plate, which releases inner blocks 20 from the floating cores. The robot arm 130 may then place the inner blocks 20 on a block conveyor, which may include an inner block conveyor 140.

Similarly, after the pair of outer block molds 122 within a station on the outer block carousel 120 reach a certain point within the rotation, the mold lid, connected stripper plate and respective cores from the compression mold press may be removed from the outer block mold cavities 124, which in turn pulls the outer blocks 30 out of the cavities. The robot arm 130 may be used to engage the pair of outer blocks 30. The floating cores may be pulled up through a stripper plate, which releases the outer blocks 30 from the floating cores. The robot arm 130 may then place the outer blocks 30 on the outer block conveyor, which may include an outer block conveyor 150 that is adjacent the inner block conveyor 140.

In various examples, the inner and outer block conveyors 140, 150 are split since they move at different speeds. The inner block conveyor 140 may be slower than the outer block conveyor 150. This may allow more time for the inner blocks 20 to cool.

In various examples, as the inner and outer blocks 20, 30 move down the inner and outer block conveyors 140, 150, they are cooled by at least one chilled sprayer 160. A press assembly 170 may be positioned downstream from the inner and outer block conveyors 140, 150 to receive the inner and outer blocks 20, 30. The press assembly 170 may be configured to press the inner block 20 into the opening 32 of the outer block 30 to form a complete block 40.

After the inner and outer blocks 20, 30 have been pressed together to form a double wall block 40, the newly formed double wall block 40 may travel down a single conveyor 180. The double wall blocks 40 may be further cooled by a chilled sprayer 162 or by air blowers blowing ambient or cooled air over the blocks. When the outer block 30 is warmer than inner block 20, and as the outer block 30 cools, it shrinks onto the inner block 20 to create a tight seal at an interface between the inner and outer blocks 20, 30.

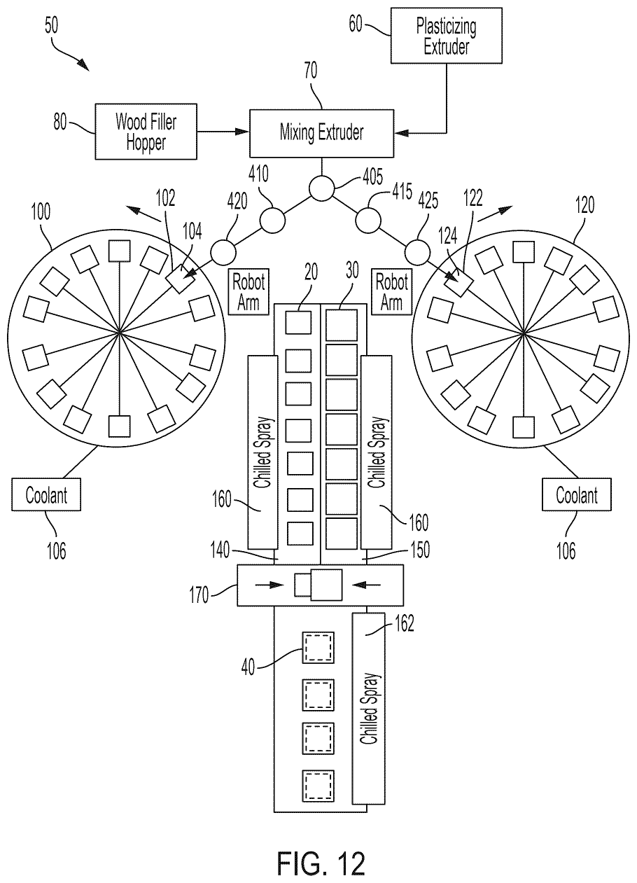

Referring now to FIG. 12, a schematic view of a compression molding system 50 used to form the double wall blocks 40 is provided, in accordance with an example embodiment. The compression molding system 50 of FIG. 12 may be configured similarly as the compression molding system 50 of FIG. 11. For example, the compression molding system 50 may comprise similar components or assemblies such as the plasticizing extruder 60, mixing extruder 70, wood filler hopper 80, inner block carousel 100, outer block carousel 120, compression press 200, chilled sprayer 160, chilled sprayer 162, press assembly 170, etc.

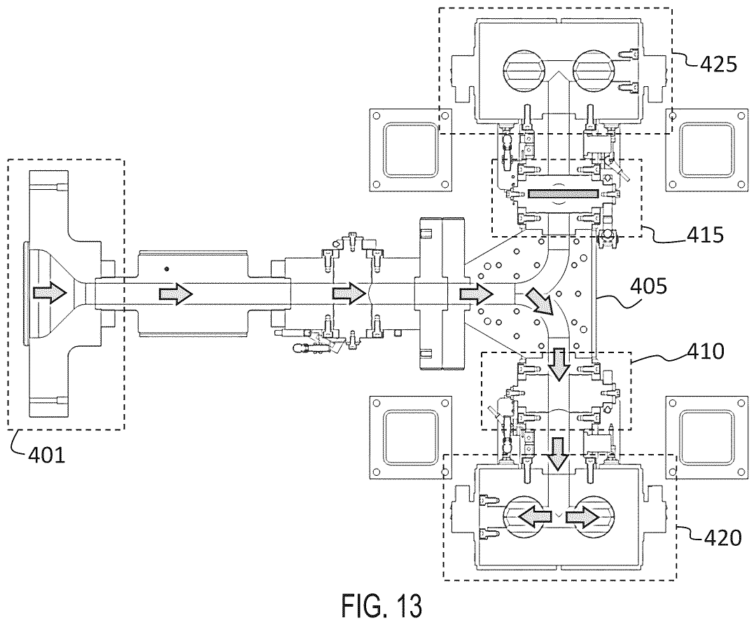

In various examples, and with reference to FIG. 13, the compression molding system 50 comprises a connecting flange 401. The connecting flange 401 may be oriented to receive the composite material 202 (FIG. 23) from the mixing extruder 70. The compression molding system 50 may comprise a splitter 405. The splitter 405 may be positioned downstream from the second extruder 70 (e.g., via the connecting flange 401) and configured to split a flow of the composite material 202 received from the second extruder 70 between a first flow and a second flow. The splitter 405 may be configured as a Y-splitter or a T-splitter.

In various examples, the compression molding system 50 comprises an inner block transfer valve 410 that is positioned downstream from the splitter 405 and oriented to receive the first flow of the composite material 202. The compression molding system 50 may comprise an outer block transfer valve 415 that is positioned downstream from the splitter 405 and oriented to receive the second flow of the composite material 202. The inner block transfer valve 410 and the outer block transfer valve 415 may be configured to alternatively open and close. For example, when the inner block transfer valve 410 is opened, the outer block transfer valve 415 may be configured to be closed, and vice-versa.

In various examples, the compression molding system 50 comprises an inner block accumulator 420 that is downstream from the inner block transfer valve 410. The compression molding system 50 may comprise an outer block accumulator 425 that is downstream from the outer block transfer valve 415. The inner block transfer valve 410 may be configured to allow the first flow of the composite material 202 to be received by the inner block accumulator 420 when the inner block transfer valve 410 is opened, and may be configured to prevent the first flow of the composite material 202 to be received by the inner block accumulator 420 when the inner block transfer valve 410 is closed. The outer block transfer valve 415 may be configured to allow the second flow of the composite material 202 to be received by the outer block accumulator 425 when the outer block transfer valve 415 is opened, and may be configured to prevent the second flow of the composite material 202 to be received by the outer block accumulator 425 when the outer block transfer valve 415 is closed.

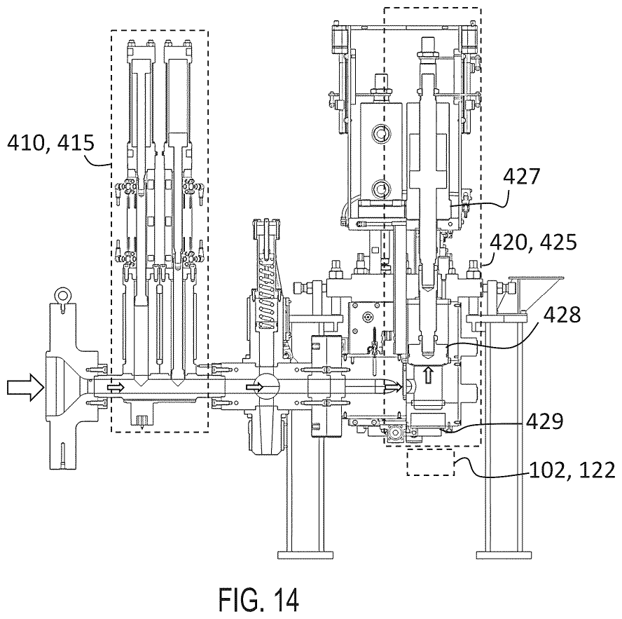

In various examples, and with reference to FIG. 14, which depicts a cross-sectional side view of a portion of the compression molding system 50 in accordance with an example embodiment, each accumulator (e.g., the inner block accumulator 420 and the outer block accumulator 425) may comprise a plunger 428 and a means to move the plunger 428, such as a hydraulic cylinder 427. Each accumulator 420, 425 may have a syringe-like configuration in that the plunger 428 may be pulled back or pushed by the pressure of the composite material 202 to receive a flow of the composite material 202 into a cavity and subsequently pushed forward to push the material from the cavity through a nozzle 429. As will be explained further, an inner block mold 102 or an outer block mold 122 may be positioned below the nozzle 429 of the accumulator 420, 425 to receive the composite material 202 from the accumulator 420, 425. The accumulators 420, 425 may be configured to measure a volume of the composite material 202 that is to be deposited into the mold cavities.

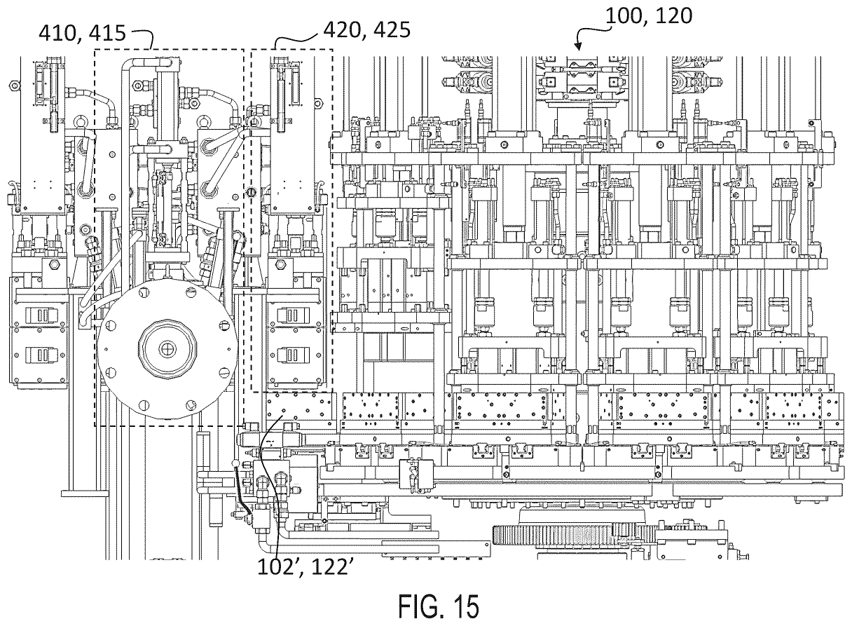

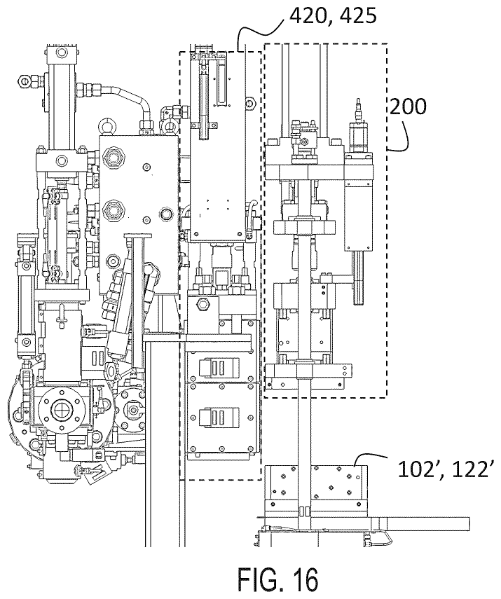

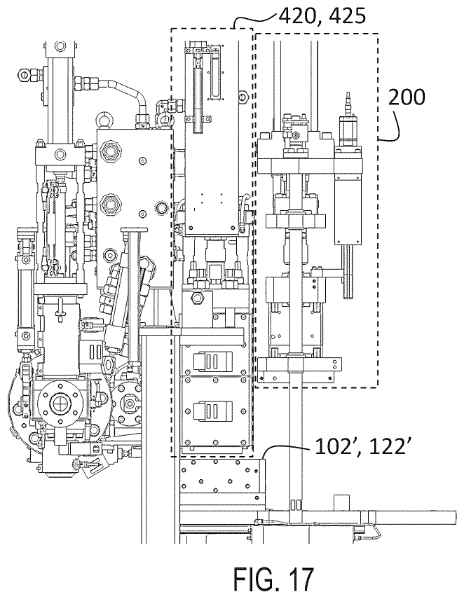

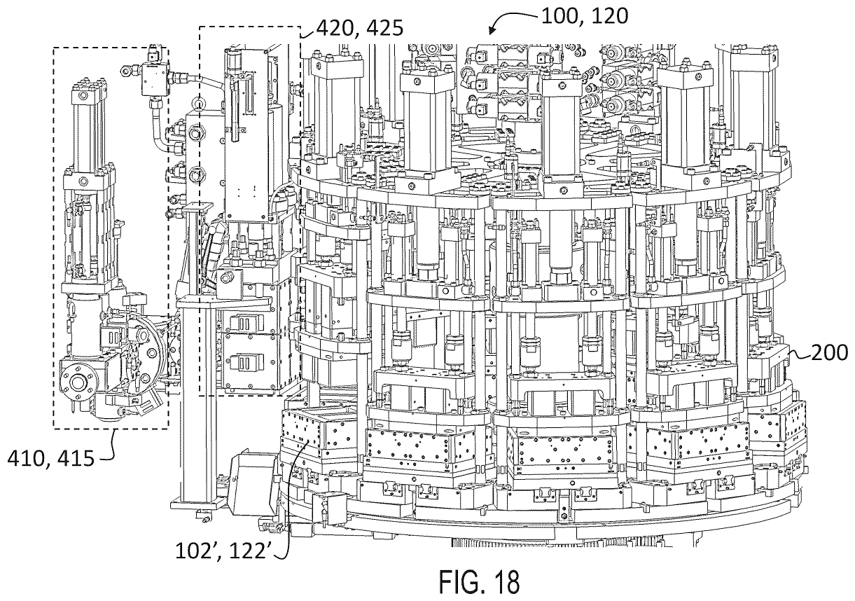

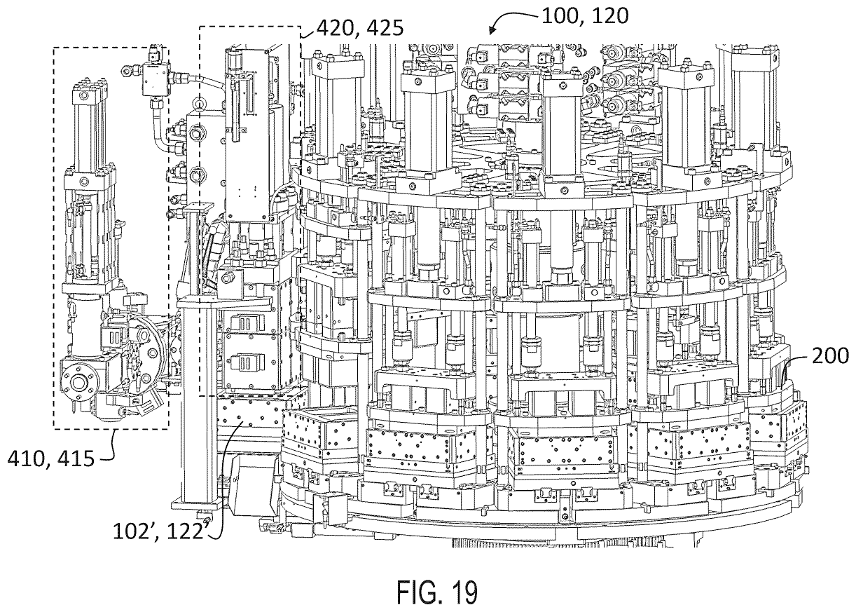

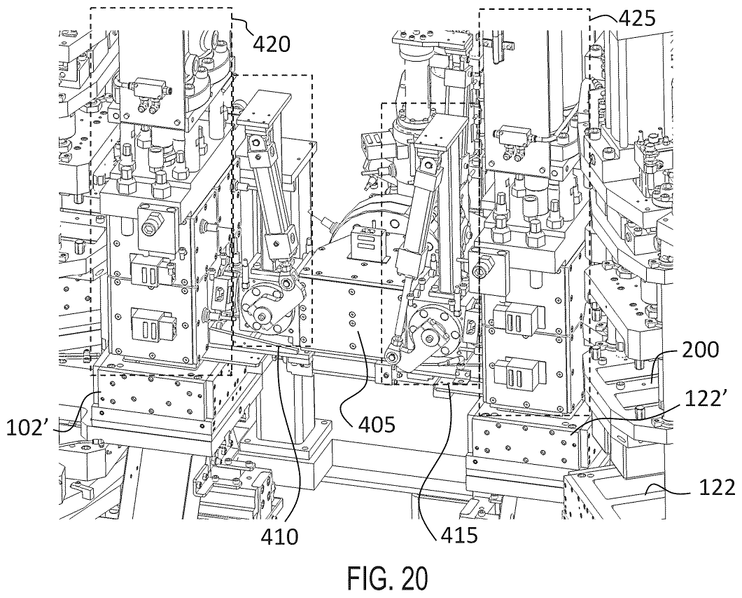

Referring now to FIGS. 15-20, various views of portions of the compression molding system 50 are provided, in accordance with an example embodiment. As discussed, each carousel 100, 120 may comprise a plurality of block assemblies (e.g., a plurality of inner block assemblies or a plurality of outer block assemblies) that each include a mold (e.g., an inner block mold 102 or an outer block mold 122). Each block assembly may be configured to move the respective mold 102′, 122′ to a first position that is under the accumulator 420, 425 when the mold is radially aligned with the accumulator 420, 425, as depicted in FIGS. 15, 17, 19, and 20. When in the first position, the mold 102′, 122′ may receive the composite material 202 from the accumulator 420, 425, such as the nozzle 429 of the accumulator 420, 425. Each block assembly may be configured to move the respective mold 102′, 122′ from the first position to a second position that is under the compression press 200 when the mold is not receiving the composite material 202, as depicted in FIGS. 16 and 18. Each block assembly may comprise various components, such as actuators, to move the respective mold to and from the first position so that the mold may receive the composite material 202 and subsequently have the composite material compressed by the compression press 200. Referring now to FIGS. 21-24, depositing the composite material 202 into the respective inner and outer block mold cavities 104, 124 will be discussed in greater detail, in accordance with an example embodiment. The transfer value 90 as discussed with reference to FIG. 11 may operate in coordination with a composite material shuttle 300.

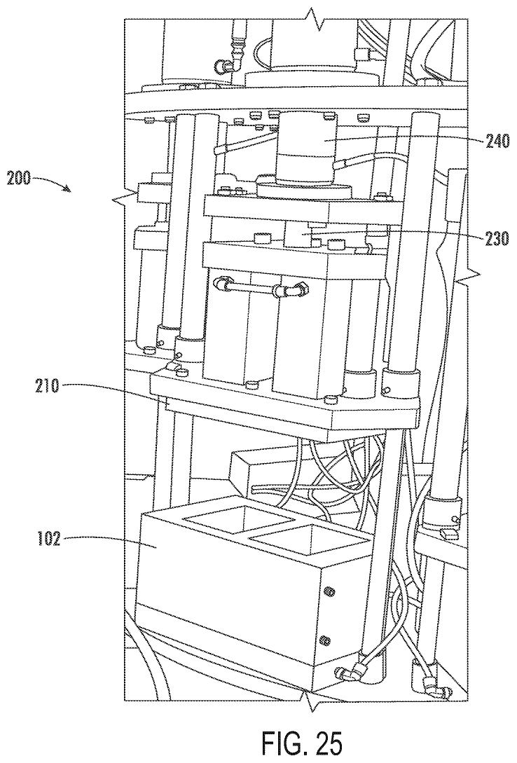

Referring now to FIGS. 25-33, the inner and outer block compression presses 200 as discussed above to form the compressed inner and outer blocks 20, 30 will be discussed in greater detail. For discussion purposes, the inner and outer block compression presses 200 will be generally referred to as a compression press 200. The compression press 200 may be configured as a multi-stage compression press and may be the same for the inner and outer block molds 102, 122.

In various examples, the compression press 200 includes a first hydraulic stage 230 and a second hydraulic stage 240, as illustrated in FIGS. 25-33. Both hydraulic stages are independently controlled by a hydraulic system 250.

In various examples, the first and second hydraulic stages 230, 240 are formed as a single unit, as illustrated. The first and second hydraulic stages 230, 240 may share a single cylinder. The first and second hydraulic stages 230, 240 may be formed as separate units such that each stage has their own cylinder.

In various examples, the inner block mold 102 is sized for a pair of inner blocks 20. The pair of inner blocks 20 may be formed using a pair of side-by-side inner block molds 102, with each inner block mold 102 being sized for a single inner block 20. As noted above, each carousel 100, 120 may be divided into stations, with each station used to form at least a pair of inner blocks 20 or at least a pair of outer blocks 30. For example, each station may be used to form two, three, four or more inner blocks 20 or outer blocks 30. To form three or more inner blocks 20 or outer blocks, the inner block molds 102 and/or outer block molds 122 may be configured accordingly. Also, various other components of the compression molding system 50, such as the accumulators 420, 425, splitter 405, transfer valves 410, 415 can be configured and/or arranged to accommodate the manufacturing of three, four or more inner blocks or outer blocks. For example, the accumulators 420, 425 may comprise three or more cavities and three or more nozzles 429 to deliver to composite material 202 to three or more block molds 102, 122. The splitter 405 may split the flow of composite material 202 into at least three separate streams of composite material 202. The compression molding system 50 can include at least three inner block transfer valves 410 and at least three outer block transfer valves 415 for each of the at least three separate streams of composite material 202.

In various examples, the compression press 200 includes a frame 211 secured to a base 213. The base 213 may be part of the inner or outer block carousels 100, 120, for example. A movable lid 210 may be carried by the frame 211 and may have a pair of openings extending therethrough. The compression press 200 may include a pair of cores 215 that are movable between a retracted position and an extended position (e.g., a partially extended position and/or a fully extended position). The pair of cores 215 may be aligned with the respective openings in the lid 210. The cores 215 may also be referred to as floating cores.

In various examples, a core 215 to be used on an inner block mold 102 may comprise a slot. The slot may have a shape that corresponds to a desired shape of the rib 21 of the inner block 20. The slot may have a tapered shape to form a tapered rib 21.

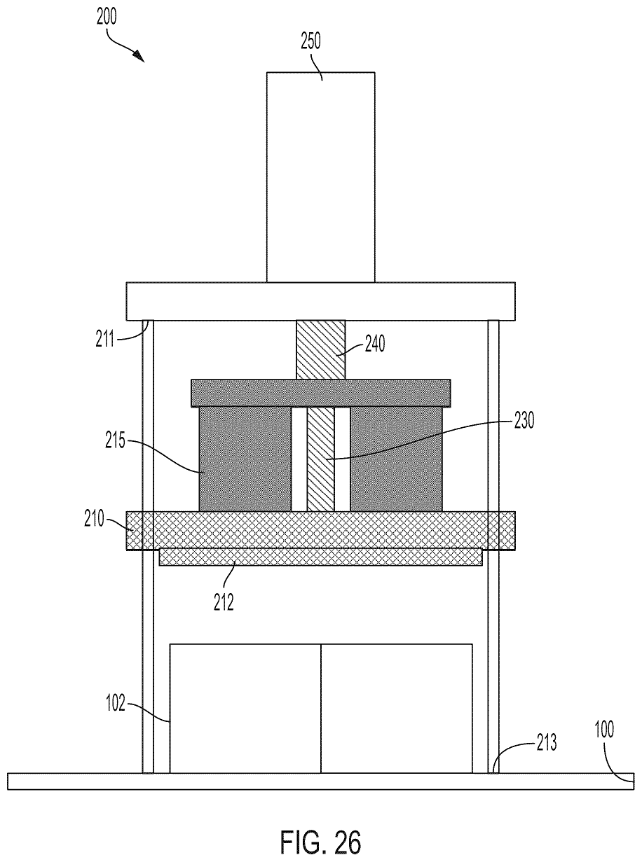

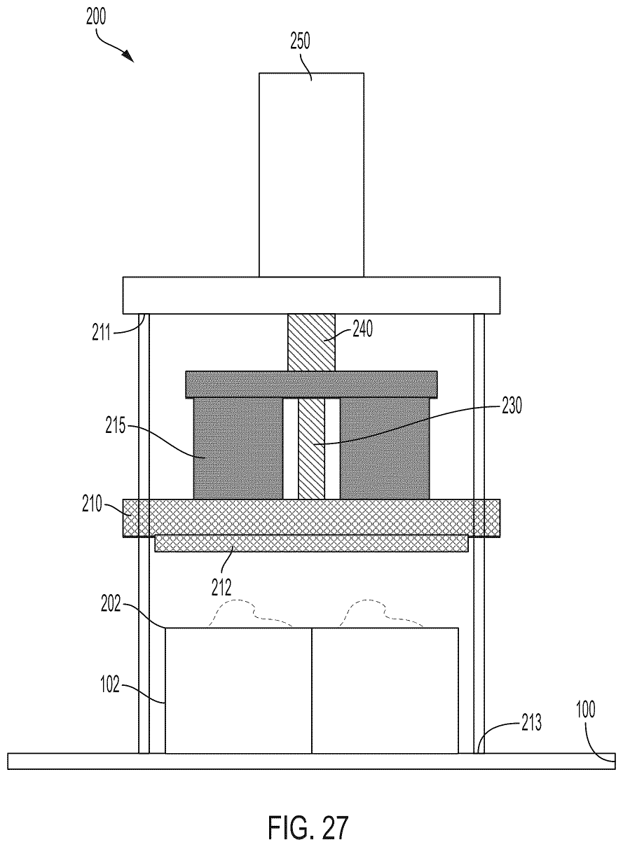

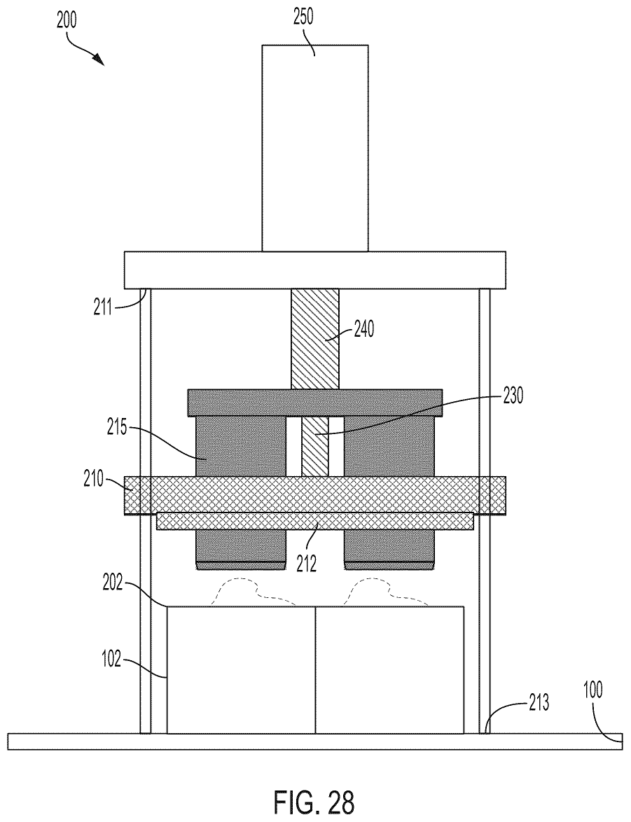

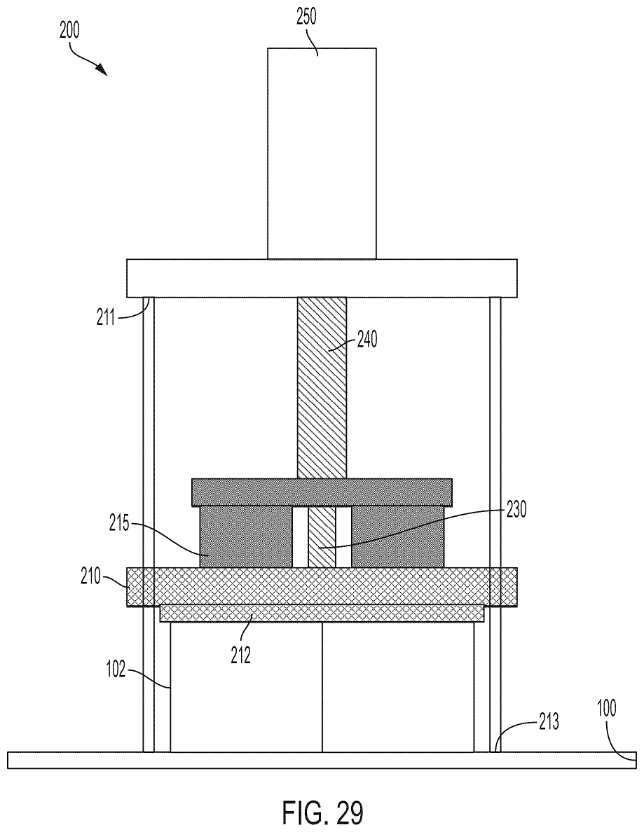

In various examples, a composite material 202 is then deposited into the cavities 104 of the inner block molds 102, as illustrated in FIG. 27. Prior to and/or while the composite material 202 is being deposited into the cavities 104 of the inner block molds 102, the mold lid 210 and stripper plate 212 may be fully open with the cores 215 retracted relative to the mold lid 210, as illustrated in FIGS. 26-27. The first hydraulic stage 230 may be carried by the frame 211 and may be configured to move the pair of cores 215 from the retracted position to a partially extended position, as illustrated in FIGS. 28-29. When the pair of cores 215 are in the partially extended position, they may extend partially through the pair of openings in the lid 210 and/or a pair of openings in the stripper plate 212. After the composite material 202 has been deposited in the respective inner block cavities 104 in the inner block molds 102, the first hydraulic stage 230 may extend out or pre-travels the core 215 about halfway past the lid 210 that is used to seal off the inner block cavities 104. The floating cores 215 may extend, at least partially, through the lid 210.

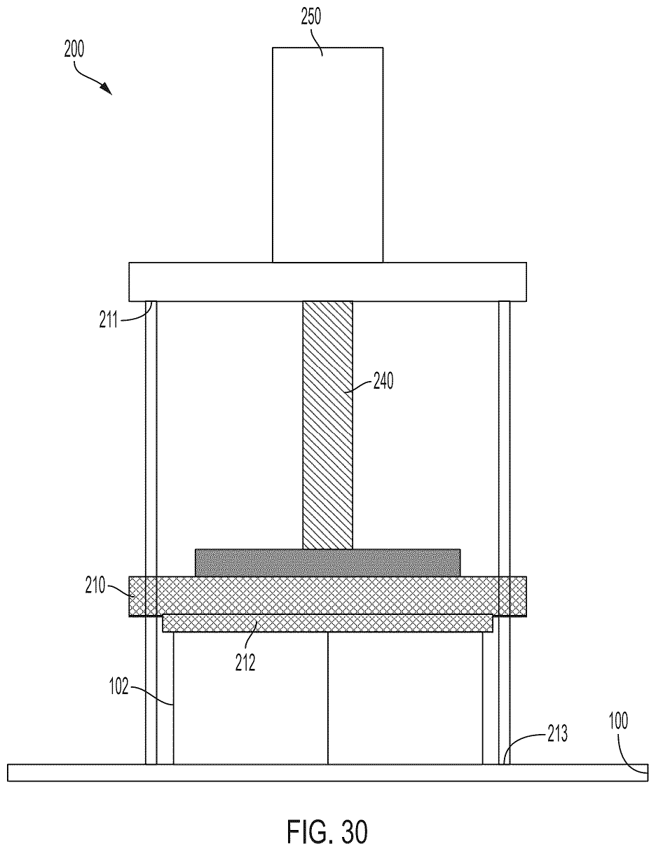

In various examples, the lid 210 and/or the stripper plate 212 and the pair of cores 215 in the partially extended position are then moved to contact a pair of molds 102 each having a cavity 104 with the material 202 deposited therein, as illustrated in FIG. 29. Pressure may be applied to the lid 210 and the pair of cores 215 may be moved to a fully extended position relative to the mold lid 210 and be positioned within the cavities 104, which may cause the material to spread out and form objects having a desired shape (e.g., inner block 20) within the pair of molds 102, as illustrated in FIG. 30. For example, the floating cores 215 may travel into the inner block cavities 104 with the composite material 202 therein. During this process, the composite material 202 may be uniformly spread out in the inner mold cavities 104 so as to prevent flashing of the composite material 202. The second hydraulic stage 240 may be carried by the frame 211 and may be configured to apply additional pressure on the lid 210 and the pair of cores 215 in the fully extended position within the cavities 104. For example, at this point in the process, the second hydraulic stage 240 may continue to press down so that the lid 210 and floating cores 215 remain under pressure with respect to the inner block molds 102.

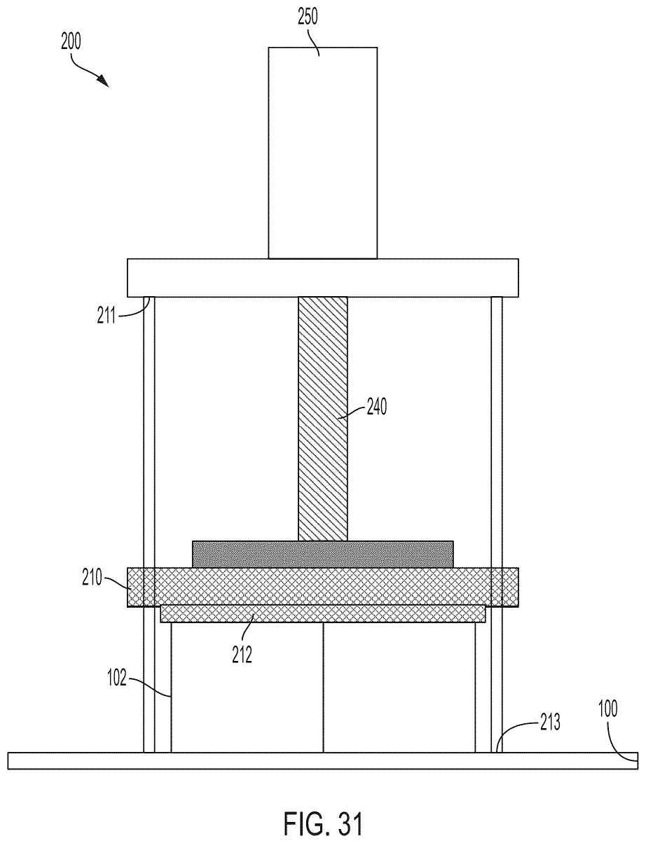

The composite material 202 within the inner mold cavities 104 may be cooled while the composite material 202 is under compression, as illustrated in FIG. 31. As the inner blocks 20 within the inner block molds 102 cool down, the inner blocks 20 may start to shrink. To prevent this shrinkage, the floating cores 215 may be placed under pressure within the inner block mold cavities 104 and push back. Also, the steel walls forming the inner block mold cavities 104 may push back against the composite material 202.

This advantageously allows dimensions of the inner blocks 20 to be nearly equal to the dimensions of the inner block cavities 104. In a typical compression molding process where a single hydraulic stage is used, the part being formed may typically shrink within 5 to 8 percent of the dimensions of the mold. The inner blocks 20 shrink 2 percent or less of the dimensions of the inner block mold cavities 104.

In various examples, the lid 210 and cores 215 used to form the blocks 20, 30 may have set movement limits that ensure that each block 20, 30 formed within the molds 102, 104 are precise. As such, it may be necessary to closely control the volume of material that is deposited into the cavities of the molds 102, 104.

The multi-stage compression press 200 may help to ensure the physical properties of the inner blocks 20. When sufficient shrinkage is introduced in a single-stage compression press, stress lines and other imperfections may start to show within the part.

After the first and second hydraulic stages 230, 240 engage the inner block mold 102 with the composite material 202 therein and maintain pressure, the inner block molds 102 may be cooled off by coolant 106 as the inner block carousel 100 rotates. In various embodiments, the coolant 106 is chilled water that circulates within the inner block molds 102 adjacent the cavities 104 therein.

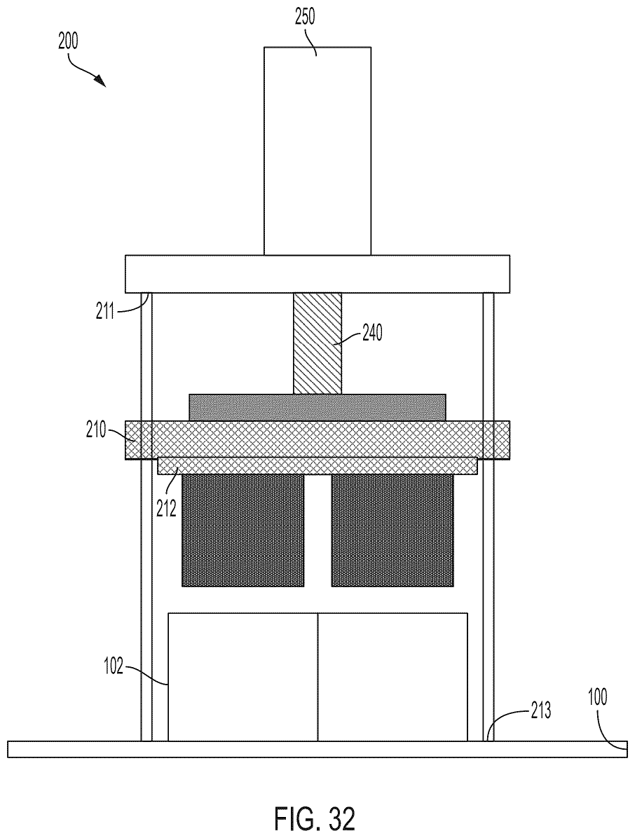

After each inner block mold 102 makes a full rotation on the inner block carousel 100, the lid 210 may be opened and the inner blocks 20 may be removed. The first and second hydraulic stages 230, 240 may release pressure so as to remove the floating cores 215 from the inner block mold cavities 104, as illustrated in FIG. 32. As the floating cores 215 are removed, the inner blocks 20 may be removed from the respective mold 102, 122 since they have shrunk onto the floating cores 215.

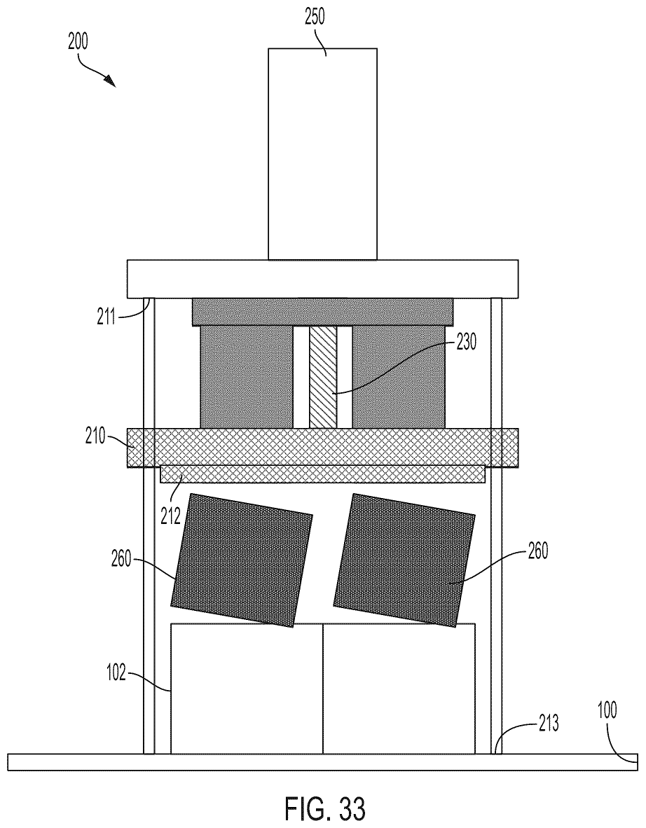

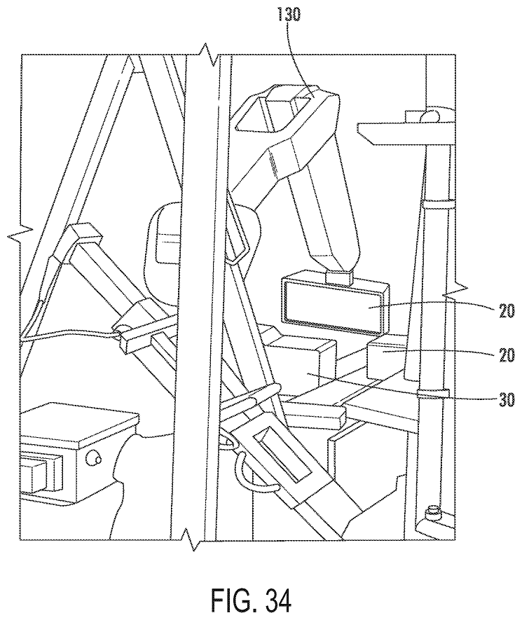

To remove the inner blocks 20 from the floating cores 215, the lid 210 may include or be coupled to a stripper plate 212 to disengage the inner blocks 20 from the floating cores 215 so that the floating cores can be fully retracted, as illustrated in FIG. 33. The stripper plate 212 and the lid 210 may be monolithic such that the stripper plate 212 is not removeable from the lid 210. In various examples, the stripper plate and the lid 210 are not monolithic and the stripper plate 212 may be removeably coupled to the lid 210. For example, fasteners, such as bolts, may couple the stripper plate 212 to the lid 210. As will be appreciated, removeably coupling the stripper plate 212 to the lid has various examples. For example, the stripper plate 212 may experience wear during use and may need to be replaced periodically. Providing a stripper plate 212 that is a separate component than the lid 210 may allow for the stripper plate 212 to be removed and replaced without removing or replacing the lid 210. As such, providing a stripper plate that is removeably coupled to the lid 210 may reduce maintenance costs. As will be discussed further, prior to the inner blocks 20 being disengaged by the lid 210, as illustrated in FIG. 33, a robot arm 130 may engage the pair of inner blocks and place them on the inner block conveyor 140, as illustrated in FIG. 34.

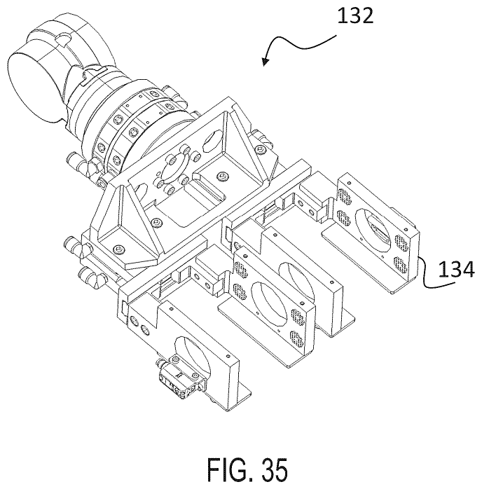

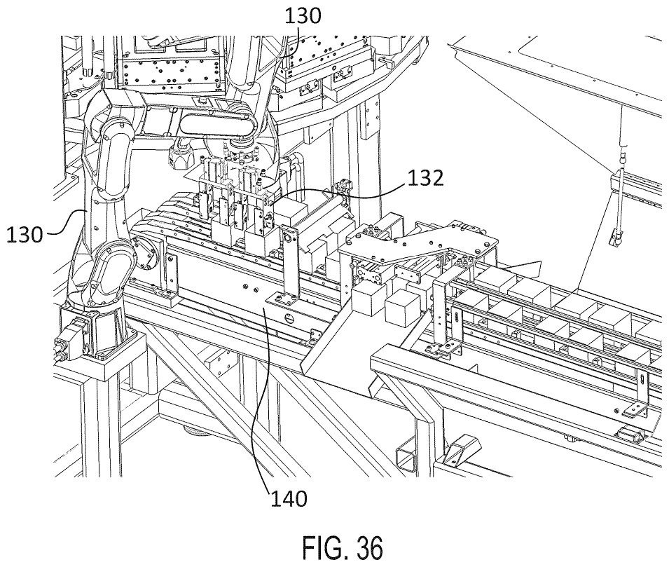

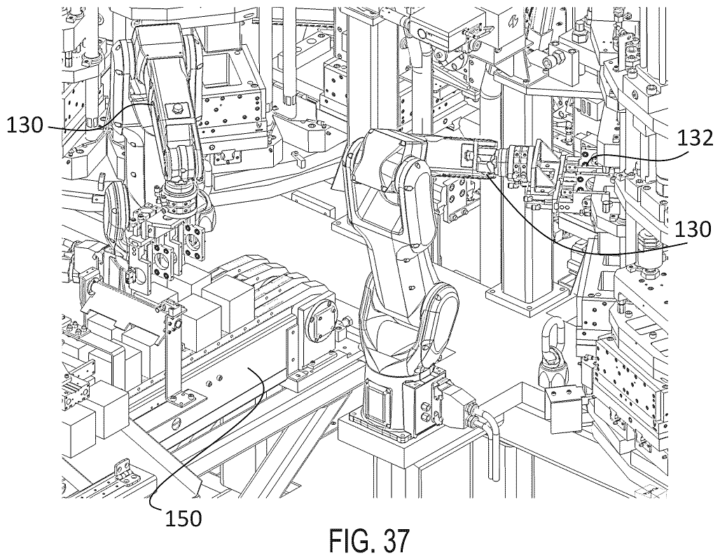

Referring now to FIGS. 35-37, various views of portions of the compression molding system 50 are provided, in accordance with an example embodiment. As discussed, the compression molding system 50 may comprise a robot arm 130 to engage (e.g., grab, suction to, lift) a pair of blocks from a respective mold (e.g., an inner block mold 102 or an outer block mold 122). For example, the robot arm 130 may comprise an end effector 132 that is configured to engage the pair of blocks simultaneously. As depicted in FIG. 35, the end effector 132 may include two pairs of fingers 134. At least one of the fingers 134 of each pair of fingers may be configured to move towards the other finger 134 to engage a block of the pair of blocks.

In various examples, the compression molding system 50 comprises at least two robot arms 130 that are configured to engage at least one block 20, 30 from a respective mold 102, 122. For example, an inner block robot arm 130 may be positioned proximate to an inner block mold assembly and configured to engage an inner block 20 as it exits the inner block mold 102, as depicted in FIG. 12. An outer block robot arm 130 may be positioned proximate to an outer block mold assembly and configured to engage an outer block 30 as it exits the outer block mold 122. In various examples, the compression molding system 50 comprises one robot arm 103 that is configured to engage the inner block 20 and the outer block 30, as depicted in FIG. 11.

In various examples, the inner block robot arm 130 may be positioned proximate to an inner block conveyor 140 to place the inner block 20 on the inner block conveyor 140. The outer block robot arm 130 may be positioned proximate to the outer block conveyor 150 to place the outer block 30 on the outer block conveyor 150. The inner block robot arm 130 and the outer block robot arm 130 may be configured to pair and position an inner block 20 with a respective outer block 30 on the block conveyors 150 such that they are laterally aligned on the block conveyor 140, 150.

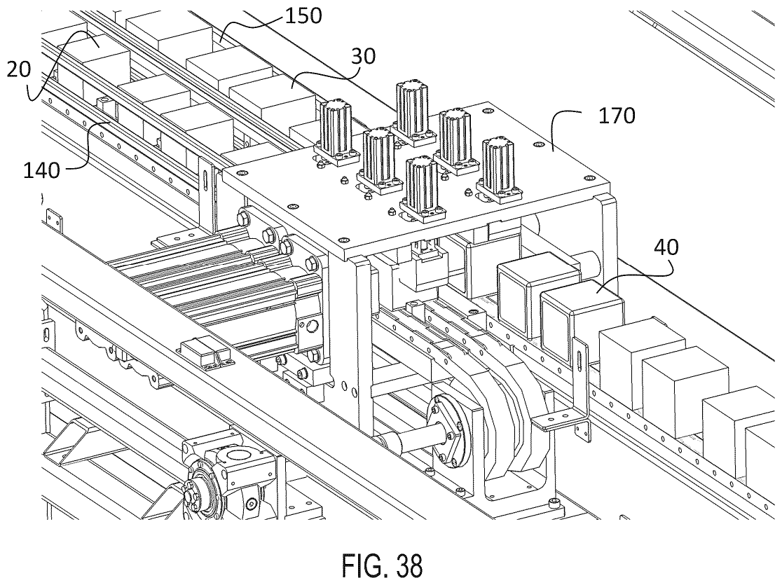

Referring now to FIG. 38, the pair of blocks 20, 30 may travel down the block conveyors 140, 150 towards the press assembly 170. The press assembly 170 may be configured to position an inner block 20 within an opening 32 of an outer block 30 to form a double wall block 40. Subsequently, the double wall block 40 may be cooled with a fluid, such as a liquid (e.g., water) or a gas (e.g., ambient or cooled air).

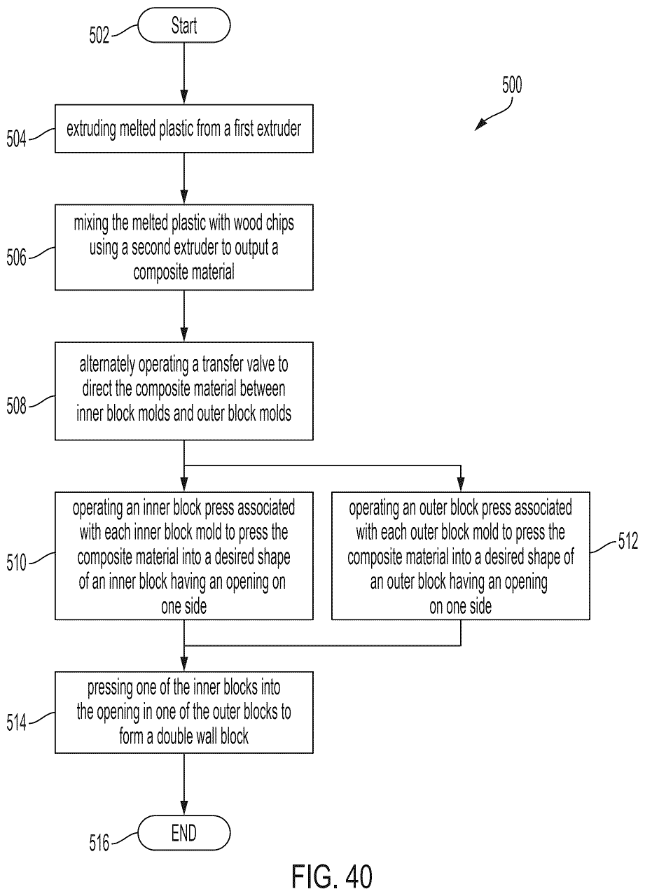

Another aspect of the disclosure is directed to a method of operating the compression molding system 50 as discussed above. For example, the method may be for operating the compression molding system 50 of FIG. 11. Reference is now directed to the flow diagram 500 in FIG. 40. From the start (Block 502), the method may include extruding melted plastic from a first extruder 60 at Block 504, and then using a second extruder 70 downstream from the first extruder to mix the melted plastic with wood chips to output a composite material at Block 506. A transfer valve 90, such as an inner block transfer valve 410 or an outer block transfer valve 415, at Block 508 may be alternately operated to direct the composite material between inner block molds 102 and outer block molds 122.

Each inner block mold 102 may have an inner block press associated therewith to press the composite material into a desired shape of an inner block 20 having an opening 22 on one side (Block 510). Each outer block mold 122 may have an outer block press associated therewith to press the composite material into a desired shape of an outer block 30 having an opening 32 on one side (Block 512). Block 510 may be performed simultaneously with and/or in parallel with Block 512, as illustrated. A press assembly 170 may be operated at Block 514 to press one of the inner blocks 20 into the opening 32 in one of the outer blocks 30 to form a double wall block 40. The method may end at Block 516.

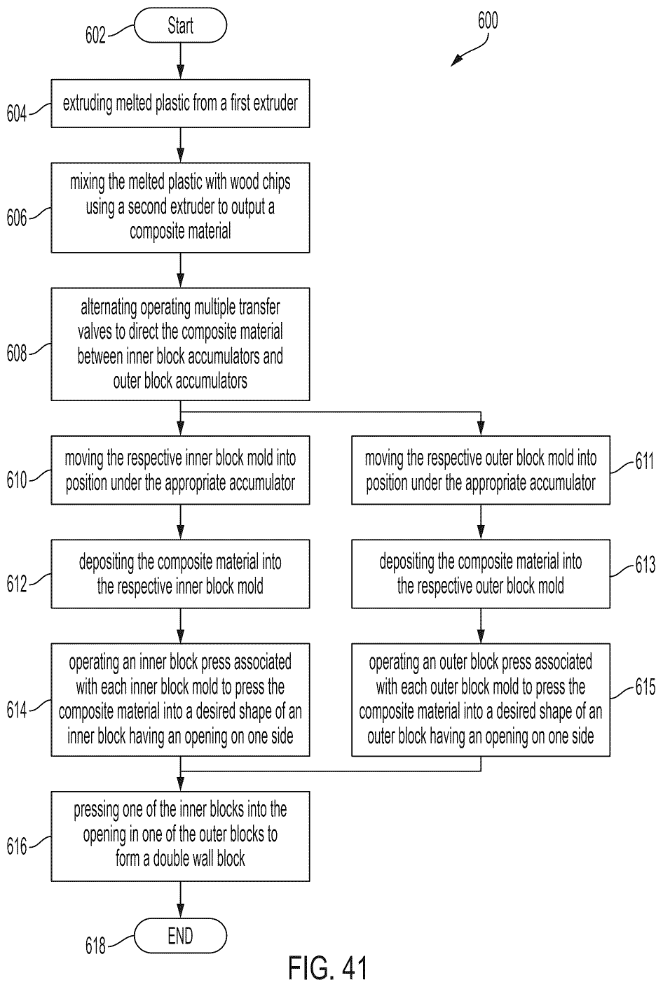

Yet another aspect of the disclosure is directed to a method of operating the compression molding system 50 as discussed above. For example, the method may be for operating the compression molding system 50 of FIG. 12. Reference is now directed to the flow diagram 600 in FIG. 41. From the start (Block 602), the method may include extruding melted plastic from a first extruder at block 604, and then using a second extruder 70 downstream from the first extruder to mix the melted plastic with wood chips to output a composite material at Block 606. Multiple transfer valves may be alternatingly operated to direct the composite material between the inner block accumulators 420 and outer block accumulators 425 at Block 608. A respective inner block mold 102 and/or outer block mold 122 may be moved into position under the appropriate accumulator(s) at Block 610 and/or Block 611, which may be performed simultaneously and/or in parallel. Composite material may be deposited in the respective inner block mold 102 and/or outer block mold 122 at Block 612 and Block 613, which may be performed simultaneously and/or in parallel.

Each inner block mold 102 may have an inner block press associated therewith to press the composite material into a desired shape of an inner block 20 having an opening 22 on one side (Block 614). Each outer block mold 122 may have an outer block press associated therewith to press the composite material into a desired shape of an outer block 30 having an opening 32 on one side (Block 615). Block 614 may be performed simultaneously with and/or in parallel with Block 615, as illustrated. A press assembly 170 may be operated at Block 616 to press one of the inner blocks 20 into the opening 32 in one of the outer blocks 30 to form a double wall block 40. The method may end at Block 618.

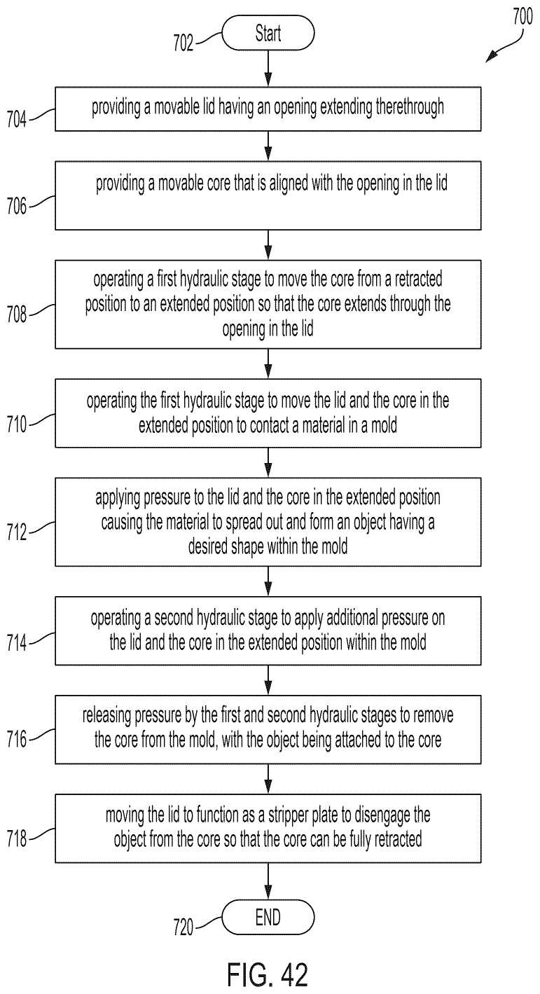

Yet another aspect of the disclosure is directed to a method of operating the compression press 200 as discussed above. Reference is now directed to the flow diagram 700 in FIG. 42. From the start (Block 702), a movable lid 210 may be carried by a frame 211 and may have an opening extending therethrough is provided at Block 704. A moveable core 215 may be provided at Block 706. The core 215 may be movable between a retracted position and an extended position (e.g., a partially extended position and/or a fully extended position). The core 215 may be aligned with the opening in the lid 210.

The method may include operating a first hydraulic stage 230 at Block 708 to move the core 215 from the retracted position to the partially extended position, with the core 215 in the partially extended position extending through the opening in the lid 210. The first hydraulic stage 230 may then move the lid 210 and the core 215 in the partially extended position at Block 710 to contact a mold 102 having a cavity 104 with material 202 deposited therein.

Pressure may be applied at Block 712 by the first hydraulic stage 230 to the lid 210 and the core 215 in the fully extended position within the cavity 104 causing the material 202 to spread out and form an object 20 having a desired shape within the mold 102. The method may further include operating a second hydraulic stage 240 at Block 714 to apply additional pressure on the lid 210 and the core 215 in the fully extended position within the cavity 104.

In various examples, pressure is released by the first and second hydraulic stages 230, 240 at Block 716 to remove the core 215 from the mold cavity 104. As the core 215 is removed, the object 20 may also be removed. To remove the object 20 from the core 215, the lid 210 may function as a stripper plate at Block 718 to disengage the object 20 from the core 215 so that the core can be fully retracted. The method may end at Block 720.

Many modifications and other embodiments will come to the mind of one skilled in the art having the benefit of the teachings presented in the foregoing descriptions and the associated drawings. For example, the above described compression molding system 50 with the compression press 200 may be modified to form other types of compression molded parts. Other types of compression molded parts may take the form of a more durable board for use in pallets, for example.

In this example, a board is placed in a mold. The board may not be uniform in size. For instance, the width of the board may vary from 4 inches to 3 inches. The board is elevated in the mold so that a composite material is compressed around the board within the mold. The composite material may have a ratio of about 50% plastic and about 50% wood. The end result is a laminated board that is uniform in dimensions.

Therefore, it is understood that the foregoing is not to be limited to the example embodiments, and that modifications and other embodiments are intended to be included within the scope of the appended claims.

1. A compression molding system comprising:
a first extruder configured to output melted plastic;
a second extruder downstream from the first extruder and oriented to mix the melted plastic with wood chips to output a composite material;
a splitter downstream from the second extruder and oriented to split a flow of the composite material between a first flow and a second flow;
an inner block transfer valve downstream from the splitter and oriented to receive the first flow of the composite material;
an outer block transfer valve downstream from the splitter and oriented to receive the second flow of the composite material;
an inner block accumulator downstream from the inner block transfer valve;
an outer block accumulator downstream from the outer block transfer valve, wherein the inner block transfer valve and the outer block transfer valve are configured to alternately direct the composite material between the inner block accumulator and the outer block accumulator;
at least one inner block assembly comprising:
at least one inner block mold to receive the composite material from the inner block accumulator, and
at least one inner block press oriented to press the composite material in the at least one inner block mold into a desired shape of at least one inner block having an opening on one side;
at least one outer block assembly comprising:
at least one outer block mold to receive the composite material from the outer block accumulator, and
at least one outer block press oriented to press the composite material in the at least one outer block mold into a desired shape of at least one outer block having an opening on one side; and
a press assembly downstream from the at least one inner and outer block assemblies, and configured to press one of the at least one inner blocks into the opening in one of the at least one outer blocks to form a double wall block.

2. The compression molding system according to claim 1, further comprising:
an inner block carousel, wherein the at least one inner block assembly comprises a plurality of inner block assemblies spaced apart on the inner block carousel; and
an outer block carousel, wherein the at least one outer block assembly comprises a plurality of outer block assemblies spaced apart on the outer block carousel,
wherein the inner and outer block carousels are configured to rotate, with the composite material alternately being deposited into the at least one inner and outer block molds as they become available on their respective inner and outer block carousels.

3. The compression molding system according to claim 1, wherein each inner block assembly is oriented to move the respective inner block mold to a first position under the inner block accumulator to receive the composite material and to a second position under the respective inner block press.

4. The compression molding system according to claim 1, further comprising:
an inner block coolant system configured to circulate a coolant through each inner block mold when the composite material therein is under pressure by the at least one inner block press associated therewith; and
an outer block coolant system configured to circulate a coolant through each outer block mold when the composite material therein is under pressure by the at least one outer block press associated therewith.

5. The compression molding system according to claim 4, wherein cooling the inner and outer block molds while under pressure allows the composite material to stabilize in order for the inner and outer blocks to be removed from their respective inner and outer block molds without being soft and sagging.

6. The compression molding system according to claim 1, further comprising:
an inner block robot arm positioned proximate to the inner block mold assembly, the inner block robot arm configured to engage the at least one inner block as the at least one inner block exits the at least one inner block mold; and
a block conveyor positioned to receive the at least one inner block from the inner block robot arm.

7. The compression molding system according to claim 6, further comprising:
an outer block robot arm positioned proximate to the outer block mold assembly, the outer block robot arm being oriented to engage the at least one outer block as the at least one outer block exits the at least one outer block mold,
wherein the block conveyor is positioned to receive the at least one outer block from the outer block robot arm, and
wherein the press assembly is oriented to receive the at least one inner block and the at least one outer block from the block conveyor.

8. The compression molding system according to claim 6, further comprising an inner block chilled sprayer proximate to the block conveyor, and configured to cool the at least one inner block as they travel on the block conveyor to the press assembly.

9. The compression molding system according to claim 8, further comprising a block chilled sprayer positioned proximate to the block conveyor, and configured to cool the at least one outer block as the at least one outer block travels on the block conveyor to the press assembly.

10. The compression molding system according to claim 1, further comprising:
a double wall block conveyor to receive the double wall block from the press assembly; and
a double wall block chilled sprayer adjacent the double wall block conveyor, and configured to cool the double wall block as it travels on the double wall block conveyor.

11. The compression molding system according to claim 10, wherein a temperature of the outer block in the double wall block is warmer than a temperature of the inner block in the double wall block, and as the outer block cools, the outer block shrinks onto the inner block to create a tight seal at an interface between the inner and outer blocks.

12. The compression molding system according to claim 1, wherein the composite material is about 50% plastic and about 50% wood.

13. The compression molding system according to claim 1, wherein the double wall block has a hollow center.

14. The compression molding system according to claim 13, wherein the inner block is a 5-sided block with the opening on a remaining side, and the outer block is a 5-sided block with the opening on a remaining side, with the inner and outer blocks being oriented so that the opening of the inner block is facing the opening of the outer block.

15. The compression molding system according to claim 1, wherein the inner block accumulator comprises a plunger and defines a cavity, and wherein the plunger is configured to be pulled back so that the first flow of the composite material is received into the cavity of the inner block accumulator.

16. The compression molding system according to claim 15, wherein the inner block accumulator comprises a nozzle, and wherein the plunger is configured to be pushed forward to push the first flow of the composite material from the cavity and through the nozzle.

17. The compression molding system according to claim 1, wherein an inner block mold that is to receive the first flow of the composite material is positioned below the inner block accumulator.

18. The compression molding system according to claim 1, further comprising a robot arm positioned proximate to the inner block mold assembly, the robot arm comprising an end effector that is oriented to engage a pair of inner block molds from the at least one inner block assembly.

19. The compression molding system according to claim 18, wherein the end effector comprises two pairs of fingers, and wherein at least one of the fingers of each pair of fingers is configured to move towards the other finger to engage a block of the pair of blocks.

20. The compression molding system according to claim 1, further comprising:
an inner block robot arm positioned proximate to the inner block mold assembly, the inner block robot arm being oriented to engage the at least one inner block as the at least one inner block exits the at least one inner block mold;
an outer block robot arm positioned proximate to the outer block mold assembly, the outer block robot arm being oriented to engage the at least one outer block as the at least one outer block exits the at least one outer block molds; and
a block conveyor positioned to receive the at least one inner block from the inner block robot arm and the at least one outer block from the outer block robot arm,
wherein the inner block robot arm and the outer block robot arm are configured to pair and position the at least one inner block with at least one outer block such that the respective inner and outer blocks, when paired and positioned, are laterally aligned on the block conveyor.
